(19) United States
(12) Patent Application Publication
(10) Pub. No.: US 2022/0236459 A1
(43) Pub. Date: Jul. 28, 2022

(54) LOW-REFLECTION STRUCTURE, LENS BARREL, AND ELECTRONIC DEVICE

(71) Applicant: JIANGXI JINGCHAO OPTICAL CO., LTD., Nanchang (CN)

(72) Inventors: Dezhong HU, Nanchang (CN); Junfu WU, Nanchang (CN); Hairong ZOU, Nanchang (CN)

(21) Appl. No.: 17/721,737

(22) Filed: Apr. 15, 2022

Related U.S. Application Data
(63) Continuation of application No. PCT/CN2019/114129, filed on Oct. 29, 2019.

(51) Int. Cl. G02B 5/00; G02B 7/02

(52) U.S. Cl. CPC G02B 5/003; G02B 7/02

(57) ABSTRACT

A low-reflection structure, a lens barrel, and an electronic device are provided. The low-reflection structure includes a light-transmission region and a light-extinction surface arranged around a circumference side of the light-transmission region. Multiple light-extinction groups are disposed at the light-extinction surface, and the multiple light-extinction groups are arranged circumferentially around the light-transmission region. Each light-extinction group has multiple light-extinction structures, and the multiple light-extinction structures of each light-extinction group are all arranged in a radial direction of the light-transmission region.

### CROSS-REFERENCE TO RELATED APPLICATIONS

This application is a continuation of International Application No. PCT/CN2019/114129, filed on Oct. 29, 2019, the entire disclosures of which is incorporated herein by reference.

### TECHNICAL FIELD

This disclosure relates to the field of image-taking, and in particular to a low-reflection structure, a lens barrel, and an electronic device.

### BACKGROUND

In recent years, users have increasing demand for taking pictures. Taking a mobile phone as an example, with rapid development of mobile phone industry, customers have special requirements for both stray light and appearance of a mobile phone camera. Taking a lens barrel as an example, reflectivity of the lens barrel is reduced by methods of coating, sandblasting, and discharging, such that ultra-black effect is realized and stray light generated by surface reflection is eliminated.

However, the coating of the lens barrel is easy to be bruised during assembly and transportation, and coating colors are relatively difficult to be guaranteed. When a sandblasted lens is processed by a mold for a long time, sand particles are easy to fall off. The discharging has a high reflectivity and a surface has a poor light-extinction effect. Similarly, accessories such as a lens, a spacer, etc., also have similar problems, therefore, a technical solution that can provide a better light-extinction effect is urgently needed.

### SUMMARY

In a first aspect, a low-reflection structure is provided in the present disclosure. The low-reflection structure includes a light-transmission region and a light-extinction surface arranged around a circumference side of the light-transmission region. Multiple light-extinction groups are disposed at the light-extinction surface, and the multiple light-extinction groups are arranged circumferentially around the light-transmission region. Each light-extinction group has multiple light-extinction structures, and the multiple light-extinction structures of each light-extinction group are all arranged in a radial direction of the light-transmission region.

In a second aspect, a lens barrel is further provided in the present disclosure. The lens barrel includes the above low-reflection structure. The lens barrel defines a lens hole and has a top surface arranged around a circumference side of the lens hole, the light-transmission region of the low-reflection structure in the first aspect is the lens hole, and the light-extinction surface of the low-reflection structure in the first aspect is the top surface.

In a third aspect, an electronic device is further provided in the present disclosure. The electronic device includes a housing and an image-taking module, where the image-taking module includes an image-taking chip and the lens barrel in the second aspect, wherein an image-taking region of the image-taking chip is aligned with the lens hole of the lens barrel. The housing defines an image-taking hole, the image-taking module is disposed in a space enclosed by the housing, and the image-taking region of the image-taking module is arranged opposite to the image-taking hole.

### BRIEF DESCRIPTION OF THE DRAWINGS

In order to describe technical solutions of implementations more clearly, the following will give a brief introduction to the accompanying drawings used for describing the implementations. Apparently, the accompanying drawings hereinafter described are some implementations of the disclosure. Based on these drawings, those of ordinary skill in the art can also obtain other drawings without creative effort.

FIG. 1 is a schematic top structural view of a low-reflection structure provided by a first implementation of the present disclosure.

FIG. 2 is a partial enlarged schematic structural view at part X1 in FIG. 1.

FIG. 3 is a schematic cross-sectional structural view of FIG. 1 from a side view.

FIG. 4 is a partial enlarged schematic structural view at part Y1 in FIG. 3.

FIG. 5 is a schematic top structural view of a low-reflection structure provided by a second implementation of the present disclosure.

FIG. 6 is a partial enlarged schematic structural view at part X2 in FIG. 5.

FIG. 7 is a schematic cross-sectional structural view of FIG. 5 from a side view.

FIG. 8 is a partial enlarged schematic structural view at part Y2 in FIG. 7.

FIG. 9 is a schematic top structural view of a low-reflection structure provided by a third implementation of the present disclosure.

FIG. 10 is a partial enlarged schematic structural view at part X3 in FIG. 9.

FIG. 11 is a schematic cross-sectional structural view of FIG. 9 from a side view.

FIG. 12 is a partial enlarged schematic structural view at part Y3 in FIG. 11.

FIG. 13 is a schematic top structural view of a low-reflection structure provided by a fourth implementation of the present disclosure.

FIG. 14 is a partial enlarged schematic structural view at part X4 in FIG. 13.

FIG. 15 is a schematic cross-sectional structural view of FIG. 13 from a side view.

FIG. 16 is a partial enlarged schematic structural view at part Y4 in FIG. 15.

FIG. 17 is a schematic top structural view of a low-reflection structure provided by a fifth implementation of the present disclosure.

FIG. 18 is a partial enlarged schematic structural view at part X5 in FIG. 17.

FIG. 19 is a schematic cross-sectional structural view of FIG. 17 from a side view.

FIG. 20 is a partial enlarged schematic structural view at part Y5 in FIG. 19.

FIG. 21 is a schematic top structural view of a low-reflection structure provided by a sixth implementation of the present disclosure.

FIG. 22 is a partial enlarged schematic structural view at part X6 in FIG. 21.

FIG. 23 is a schematic cross-sectional structural view of FIG. 21 from a side view.

FIG. 24 is a partial enlarged schematic structural view at part Y6 in FIG. 23.

FIG. 25 is a schematic arrangement view of a low-reflection structure adopting a triangular light-extinction structure in the present disclosure.

FIG. 26 is a schematic principle view of a low-reflection structure adopting an intermediate light-extinction structure in the present disclosure.

FIG. 27 is a schematic top structural view of a low-reflection structure provided by a seventh implementation of the present disclosure.

FIG. 28 is a partial enlarged schematic structural view at part X7 in FIG. 27.

FIG. 29 is a schematic cross-sectional structural view of FIG. 27 from a side view.

FIG. 30 is a partial enlarged schematic structural view at part Y7 in FIG. 29.

FIG. 31 is a schematic top structural view of a low-reflection structure provided by an eighth implementation of the present disclosure.

FIG. 32 is a partial enlarged schematic structural view at part X8 in FIG. 31.

FIG. 33 is a schematic cross-sectional structural view of FIG. 31 from a side view.

FIG. 34 is a partial enlarged schematic structural view at part Y8 in FIG. 33.

FIG. 35 is a schematic top view of a low-reflection structure provided by a ninth implementation of the present disclosure.

FIG. 36 is a partial enlarged schematic structural view at part X9 in FIG. 35.

FIG. 37 is a schematic cross-sectional structural view of FIG. 35 from a side view.

FIG. 38 is a partial enlarged schematic structural view at part Y9 in FIG. 37.

FIG. 39 is a schematic top structural view of a low-reflection structure provided by a tenth implementation of the present disclosure.

FIG. 40 is a partial enlarged schematic structural view at part X10 in FIG. 39.

FIG. 41 is a schematic cross-sectional structural view of FIG. 39 from a side view.

FIG. 42 is a partial enlarged schematic structural view at part Y10 in FIG. 41.

FIG. 43 is a schematic top structural view of a low-reflection structure provided by an eleventh implementation of the present disclosure.

FIG. 44 is a partial enlarged schematic structural view at part X11 in FIG. 43.

FIG. 45 is a schematic cross-sectional structural view of FIG. 43 from a side view.

FIG. 46 is a partial enlarged schematic structural view at part Y11 in FIG. 45.

FIG. 47 is a schematic top structural view of a low-reflection structure provided by a twelfth implementation of the present disclosure.

FIG. 48 is a partial enlarged schematic structural view at part X12 in FIG. 47.

FIG. 49 is a schematic cross-sectional structural view of FIG. 47 from a side view.

FIG. 50 is a partial enlarged schematic structural view at part Y12 in FIG. 49.

FIG. 51 is a schematic top structural view of a low-reflection structure provided by a thirteenth implementation of the present disclosure.

FIG. 52 is a partial enlarged schematic structural view at part X13 in FIG. 51.

FIG. 53 is a schematic cross-sectional structural view of FIG. 51 from a side view.

FIG. 54 is a partial enlarged schematic structural view at part Y13 in FIG. 53.

FIG. 55 is a schematic top structural view of a low-reflection structure provided by a fourteenth implementation of the present disclosure.

FIG. 56 is a partial enlarged schematic structural view at part X14 in FIG. 55.

FIG. 57 is a schematic cross-sectional structural view of FIG. 55 from a side view.

FIG. 58 is a partial enlarged schematic structural view at part Y14 in FIG. 57.

FIG. 59 is a schematic top structural view of a low-reflection structure provided by a fifteenth implementation of the present disclosure.

FIG. 60 is a partial enlarged schematic structural view at part X15 in FIG. 59.

FIG. 61 is a schematic cross-sectional structural view of FIG. 59 from a side view.

FIG. 62 is a partial enlarged schematic structural view at part Y15 in FIG. 61.

FIG. 63 is a schematic top structural view of a low-reflection structure provided by a sixteenth implementation of the present disclosure.

FIG. 64 is a partial enlarged schematic structural view at part X16 in FIG. 63.

FIG. 65 is a schematic cross-sectional structural view of FIG. 63 from a side view.

FIG. 66 is a partial enlarged schematic structural view at part Y16 in FIG. 65.

FIG. 67 is a schematic top structural view of a low-reflection structure provided by a seventeenth implementation of the present disclosure.

FIG. 68 is a partial enlarged schematic structural view at part X17 in FIG. 67.

FIG. 69 is a schematic cross-sectional structural view of FIG. 67 from a side view.

FIG. 70 is a partial enlarged schematic structural view at part Y17 in FIG. 69.

FIG. 71 is a schematic top structural view of a low-reflection structure provided by an eighteenth implementation of the present disclosure.

FIG. 72 is a partial enlarged schematic structural view at part X18 in FIG. 71.

FIG. 73 is a schematic cross-sectional structural view of FIG. 71 from a side view.

FIG. 74 is a partial enlarged schematic structural view at part Y18 in FIG. 73.

FIG. 75 is a schematic top structural view of a low-reflection structure provided by a nineteenth implementation of the present disclosure.

FIG. 76 is a schematic cross-sectional structural view of FIG. 75, taken along A-A.

FIG. 77 is a schematic cross-sectional structural view of FIG. 75, taken along B-B.

FIG. 78 is a schematic principle view 1 illustrating arrangement of a height of a light-extinction structure of a low-reflection structure in the present disclosure.

FIG. 79 is a schematic principle view 2 illustrating arrangement of a height of a light-extinction structure of a low-reflection structure in the present disclosure.

FIG. 80 is a schematic principle view 1 illustrating arrangement of a draft angle of a light-extinction structure of a low-reflection structure in the present disclosure.

FIG. 81 is a schematic principle view 2 illustrating arrangement of a draft angle of a light-extinction structure of a low-reflection structure in the present disclosure.

FIG. 82 is a schematic principle view 1 illustrating arrangement of a distance between light-extinction structures of a low-reflection structure in the present disclosure.

FIG. 83 is a schematic principle view 2 illustrating arrangement of a distance between light-extinction structures of a low-reflection structure in the present disclosure.

FIG. 84 is a schematic view illustrating arrangement of a light-extinction surface of a low-reflection structure in the present disclosure.

FIG. 85 is a schematic structural view illustrating a lens barrel provided by implementations of the present disclosure.

FIG. 86 is a schematic structural view illustrating an electronic device provided by implementations of the present disclosure.

Reference signs of the accompanying drawings are as follows.

11, light-transmission region; 12, light-extinction surface; 121, inner boundary; 122, outer boundary; 13, light-extinction group; 131, light-extinction structure; 14, intermediate light-extinction group; 141, intermediate light-extinction structure; 100, lens barrel; 101, lens hole; 102, top surface; 200, electronic device; 201, image-taking module; 202, image-taking chip; 203, image-taking region; 204, housing; 205, image-taking hole.

### DETAILED DESCRIPTION

Technical solutions in implementations of the present disclosure will be described clearly and completely hereinafter with reference to the accompanying drawings in the implementations of the present disclosure.

The present disclosure aims to provide a low-reflection structure, a lens barrel, a lens, a spacer, an image-taking module, and an electronic device, so as to solve a problem of a poor light-extinction effect of an existing image-taking technology.

In order to solve the above technical problem, a low-reflection structure is provided in the present disclosure. The low-reflection structure includes a light-transmission region and a light-extinction surface arranged around a circumference side of the light-transmission region. Multiple light-extinction groups are disposed at the light-extinction surface, and the multiple light-extinction groups are arranged circumferentially around the light-transmission region. Each light-extinction group has multiple light-extinction structures, and the multiple light-extinction structures of each light-extinction group are all arranged in a radial direction of the light-transmission region.

In an implementation, the multiple light-extinction structures of each light-extinction group are arranged at regular intervals. A benefit of this method is that regular arrangement of light-extinction structures is realized to reduce processing difficulty.

In an implementation, a distance between adjacent light-extinction structures ranges from 0.005 mm to 0.1 mm, in the radial direction of the light-transmission region. A benefit of this method is that by controlling a size of a distance between light-extinction structures, light can be reflected more times between adjacent light-extinction structures, such that light energy can be reduced, and a better light-extinction effect can be realized.

In an implementation, a light-extinction structure is a boss protrudingly formed from the light-extinction surface. Gaps are defined between bosses. When light is incident into the gaps, a light-extinction effect can be realized by multiple reflections, and meanwhile processing difficulty of the light-extinction structure can be reduced to reduce production costs.

In an implementation, a height of the light-extinction structure ranges from 0.005 mm to 0.1 mm. A benefit of this method is that a gap between adjacent light-extinction structures is ensured to have a sufficient depth, such that light can be reflected multiple times in the gap to optimize the light-extinction effect.

In an implementation, a draft angle is defined between a side surface of the light-extinction structure and the light-extinction surface, and the draft angle of the light-extinction structure ranges from 0° to 20°. A benefit of this method is that the draft angle enables light to be reflected multiple times between adjacent light-extinction structures, such that light energy is reduced, the light-extinction effect becomes better, and a mold is easy to remove in actual production at the same time.

In an implementation, the light-extinction structure is a groove depressively defined from the light-extinction surface. An inner cavity is defined in each groove. When light is incident into the inner cavity, the light-extinction effect can be realized by multiple reflections, and meanwhile processing difficulty of the light-extinction structure can be reduced to reduce production costs.

In an implementation, a depth of the light-extinction structure ranges from 0.005 mm to 0.1 mm. A benefit of this method is that the light-extinction structure is ensured to have a sufficient depth, such that light can be reflected multiple times inside the light-extinction structure, to optimize the light-extinction effect as far as possible on condition that industrial production can be realized.

In an implementation, a draft angle is defined between a side surface of the light-extinction structure and the light-extinction surface, and the draft angle of the light-extinction structure ranges from 0° to 20°. A benefit of this method is that the draft angel enables light to be reflected multiple times inside the light-extinction structure, such that light energy is reduced, the light-extinction effect becomes better, and a mold is easy to remove in actual production at the same time.

In an implementation, a shape of the light-extinction structure is a triangle, a parallelogram, a trapezoid, a hexagon, a sector, or a circle. A benefit of this method is that shape complexity of the light-extinction structure is reduced to facilitate processing of the light-extinction structure.

In an implementation, the light-extinction structure has multiple side edges, and a length of a shortest side edge of the light-extinction structure ranges from 0.01 mm to 0.3 mm. A benefit of this method is that processing difficulty of the light-extinction structure is reduced to reduce production costs.

In an implementation, the light-extinction structure is a circle and a diameter of the light-extinction structure ranges from 0.01 mm to 0.3 mm. A benefit of this method is that processing difficulty of the light-extinction structure is reduced to reduce production costs.

In an implementation, the light-extinction structure adjacent to the light-transmission region is smaller than a light-extinction away from the light-transmission region for each two adjacent light-extinction structures in each light-extinction group, to define an included angle of 1°˜30° between adjacent light-extinction groups. A benefit of this method is that structures of light-extinction groups change linearly, such that the light-extinction effect remains uniform.

In an implementation, multiple intermediate light-extinction groups are further disposed at the light-extinction surface, and an intermediate light-extinction group is disposed between adjacent light-extinction groups. Each intermediate light-extinction group has multiple intermediate light-extinction structures, and the multiple intermediate light-extinction structures of each intermediate light-extinction group are all arranged in the radial direction of the light-transmission region. A benefit of this method is that a distance between light-extinction groups can be reduced, and multiple reflections of light are realized to improve the light-extinction effect.

In an implementation, the multiple intermediate light-extinction structures of each intermediate light-extinction group are arranged at regular intervals. A benefit of this method is that regular arrangement of intermediate light-extinction structures is realized to reduce processing difficulty.

In an implementation, a distance between adjacent intermediate light-extinction structures ranges from 0.005 mm to 0.1 mm, in the radial direction of the light-transmission region. A benefit of this method is that by controlling a distance between intermediate light-extinction structures, light can be reflected more times between adjacent intermediate light-extinction structures, such that light energy can be reduced, and better the light-extinction effect can be realized.

In an implementation, an intermediate light-extinction structure is a boss protrudingly formed from the light-extinction surface. Gaps are defined between bosses. When light is incident into the gaps, the light-extinction effect can be realized by multiple reflections, and meanwhile processing difficulty of the intermediate light-extinction structure can be reduced to reduce production costs.

In an implementation, a height of the intermediate light-extinction structure ranges from 0.005 mm to 0.1 mm. A benefit of this method is that a gap between adjacent intermediate light-extinction structures is ensured to have a sufficient depth, such that light can be reflected multiple times in the gap to optimize the light-extinction effect.

In an implementation, a draft angle is defined between a side surface of the intermediate light-extinction structure and the light-extinction surface, and the draft angle of the intermediate light-extinction structure ranges from 0° to 20°. A benefit of this method is that the draft angle enables light to be reflected multiple times between adjacent intermediate light-extinction structures, such that light energy is reduced, the light-extinction effect becomes better, and a mold is easy to remove in actual production at the same time.

In an implementation, the intermediate light-extinction structure is a groove depressively defined from the light-extinction surface. An inner cavity is defined in each groove. When light is incident into the inner cavity, the light-extinction effect can be realized by multiple reflections, and meanwhile processing difficulty of the intermediate light-extinction structure can be reduced to reduce production costs.

In an implementation, a depth of the intermediate light-extinction structure ranges from 0.005 mm to 0.1 mm. A benefit of this method is that the intermediate light-extinction structure is ensured to have a sufficient depth, such that light can reflect multiple times inside the intermediate light-extinction structure, to optimize the light-extinction effect as far as possible on condition that industrial production can be realized.

In an implementation, a draft angle is defined between a side surface of the intermediate light-extinction structure and the light-extinction surface, and the draft angle of the intermediate light-extinction structure ranges from 0° to 20°. A benefit of this method is that the draft angel enables light to be reflected multiple times inside the intermediate light-extinction structure, such that light energy is reduced, the light-extinction effect becomes better, and a mold is easy to remove in actual production at the same time.

In an implementation, a shape of the intermediate light-extinction structure is a triangle, a parallelogram, a trapezoid, a hexagon, a sector, or a circle. A benefit of this method is that shape complexity of the intermediate light-extinction structure is reduced to facilitate processing of the light-extinction structure.

In an implementation, the intermediate light-extinction structure has multiple side edges, and a length of a shortest side edge of the intermediate light-extinction structure ranges from 0.01 mm to 0.3 mm. A benefit of this method is that processing difficulty of the intermediate light-extinction structure is reduced to reduce production costs.

In an implementation, the intermediate light-extinction structure is a circle and a diameter of the intermediate light-extinction structure ranges from 0.01 mm to 0.3 mm. A benefit of this method is that processing difficulty of the intermediate light-extinction structure is reduced to reduce production costs.

In an implementation, the light-extinction structure and the intermediate light-extinction structure are arranged in alternation in the radial direction of the light-transmission region. A benefit of this method is that gap regions between light-extinction structures in the radial direction of the light-transmission region are filled, to further improve the light-extinction effect.

In an implementation, the light-extinction structure and the intermediate light-extinction structure are arranged in alternation in a circumferential direction around the light-transmission region. A benefit of this method is that gap regions between light-extinction structures in the circumferential direction around the light-transmission region are filled, to further improve the light-extinction effect.

In an implementation, a boundary of the light-extinction surface adjacent to the light-transmission region is an inner boundary, and a distance between the inner boundary and a center of the light-transmission region ranges from 1 mm to 5 mm. A benefit of this method is that the light-extinction surface can be controlled to be arranged at an appropriate position, such that augment of production costs is avoid due to excessive arrangement of an effect structure.

In an implementation, a boundary of the light-extinction surface away from the light-transmission region is an outer boundary, and a distance between the outer boundary and a center of the light-transmission region ranges from 2 mm to 15 mm. A benefit of this method is that the light-extinction surface can be controlled to be arranged at an appropriate position, such that augment of production costs is avoided due to excessive arrangement of an effect structure.

In an implementation, the light-extinction structure includes a boss protrudingly formed from the light-extinction surface and a groove depressively defined from the light-extinction surface, and a boss-shaped light-extinction structure and a groove-shaped light-extinction structure are arranged in alternation in the radial direction of the light-transmission region. A benefit of this method is that a reflection area in the radial direction of the light-transmission region can be reduced to improve the light-extinction effect.

In an implementation, the boss-shaped light-extinction structure and the groove-shaped light-extinction structure are arranged in alternation in the circumferential direction around the light-transmission region. A benefit of this method is that a reflection area in the circumferential direction around the light-transmission region can be reduced to improve the light-extinction effect.

In order to solve the above technical problems, a lens barrel is further provided in the present disclosure. The lens barrel includes the above low-reflection structure. The lens barrel defines a lens hole and has a top surface arranged around a circumference side of the lens hole, the light-transmission region of the low-reflection structure is the lens hole, and the light-extinction surface of the low-reflection structure is the top surface.

In order to solve the above technical problems, a lens is further provided in the present disclosure. The lens includes the above low-reflection structure. The lens has a light-passing region and a lens plane arranged around a circumference side of the light-passing region, the light-transmission region of the low-reflection structure is the light-passing region, and the light-extinction surface of the low-reflection structure is the lens plane.

In order to solve the above technical problems, a spacer is further provided in the present disclosure. The spacer includes the above low-reflection structure. The spacer defines a through hole and has a base surface arranged around a circumference side of the through hole, the light-transmission region of the low-reflection structure is the through hole, and the light-extinction surface of the low-reflection structure is the base surface.

In order to solve the above technical problems, an image-taking module is further provided in the present disclosure. The image-taking module includes an image-taking chip and the above lens barrel, where an image-taking region of the image-taking chip is aligned with the lens hole of the lens barrel.

In order to solve the above technical problems, an image-taking module is further provided in the present disclosure. The image-taking module includes an image-taking chip and the above lens, where an image-taking region of the image-taking chip is aligned with the light-passing region of the lens.

In order to solve the above technical problems, an image-taking module is further provided in the present disclosure. The image-taking module includes an image-taking chip and the above spacer, where an image-taking region of the image-taking chip is aligned with the through hole of the spacer.

In order to solve the above technical problems, an electronic device is further provided in the present disclosure. The electronic device includes a housing and the above image-taking module, where the housing defines an image-taking hole, the image-taking module is disposed in a space enclosed by the housing, and the image-taking region of the image-taking module is arranged opposite to the image-taking hole.

Beneficial effects of the present disclosure are as follows.

Since multiple light-extinction groups are disposed at the light-extinction surface, the multiple light-extinction groups are arranged circumferentially around the light-transmission region, and each light-extinction group has multiple light-extinction structures, the multiple light-extinction structures will be regularly arranged at the light-extinction surface of the low-reflection structure, which will greatly reduce a reflection area to improve a light-extinction effect.

Particularly, the multiple light-extinction structures of each light-extinction group are arranged in a radial direction of the light-transmission region. A benefit is that after being processed in a radial direction of the light-transmission region by a device, a light-extinction group can be manufactured. Compared with complex arrangement of light-extinction structures, this method greatly reduces processing times, therefore, processing difficulty and production cost are greatly reduced.

Reference can be made to FIG. 1 to FIG. 4, in a first implementation of a low-reflection structure of the present disclosure, the low-reflection structure is provided with a light-transmission region 11 and a light-extinction surface 12 arranged around a circumference side of the light-transmission region 11. Multiple light-extinction groups 13 are disposed at the light-extinction surface 12, and the multiple light-extinction groups 13 are arranged circumferentially around the light-transmission region 11. Each light-extinction group 13 has multiple light-extinction structures 131, and the multiple light-extinction structures 131 of each light-extinction group 13 are all arranged in a radial direction of the light-transmission region 11.

Specifically, a light-extinction structure 131 can be set as a boss protrudingly formed from the light-extinction surface 12. In this case, the light-extinction structure 131 can be set as a hexagonal boss, that is, each light-extinction group 13 consists of multiple hexagonal bosses, the multiple hexagonal bosses are arranged linearly, adjacent hexagonal bosses are spaced apart from each other, and the multiple hexagonal bosses are arranged to extend to a geometric center of the light-transmission region 11. Therefore, in this case, it can be understood that the multiple light-extinction groups 13 are respectively arranged in different radial directions of the light-transmission region 11, to realize regular arrangement of light-extinction structures 131.

If the light-extinction structures 131 are randomly arranged, the light-extinction structures 131 can also realize a light-extinction effect by reflecting light. However, since the light-extinction structures 131 are irregularly arranged at all parts of the light-extinction surface 12, the light-extinction effect is not uniform at all parts of the light-extinction surface 12, and it is difficult to ensure that required light-extinction effect can be realized everywhere at the light-extinction surface 12. It is advantageous that regular arrangement of the light-extinction structures 131 can ensure consistent light-extinction effects of all parts of the light-extinction surface 12 and facilitate designers to simulate and calculate the light-extinction effect, in other words, an existing problem that stray light is difficult to be eliminated is effectively solved.

It should be noted that in order to improve the light-extinction effect of the low-reflection structure, arrangement regularity of the light-extinction structures 131 can be improved. For example, the multiple light-extinction structures 131 of each light-extinction group 13 can be arranged at regular intervals, and in order to ensure the light-extinction effect, a distance between adjacent light-extinction structures 131 should range from 0.005 mm to 0.1 mm in the radial direction of the light-transmission region 11, such as 0.005 mm, 0.01 mm, 0.1 mm, etc.

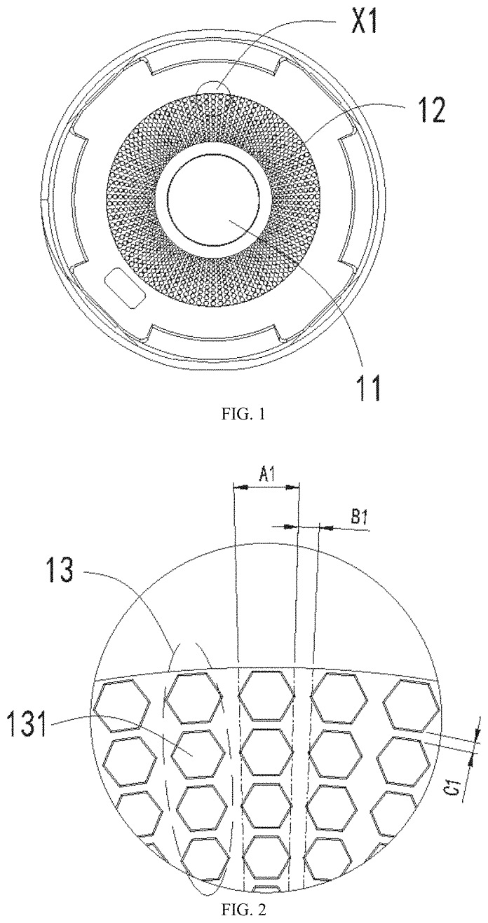

Specifically, a direction illustrated in FIG. 2 is taken as a reference direction. Between two adjacent light-extinction structures 131, a distance between a lowest side of an upper light-extinction structure 131 and an uppermost side of a lower light-extinction structure 131 is C1, where C1 ranges from 0.005 mm to 0.1 mm in this case. In a same light-extinction group 13, distances between light-extinction structures 131 are identical, therefore, each light-extinction structure 131 is ensured to have consistent light-extinction effect in the radial direction of the light-transmission region 11. The distance between the light-extinction structures 131 is set to be within 0.005 mm˜0.1 mm, which aims to reduce a reflection distance of light, such that light can be reflected and canceled out between adjacent light-extinction structures 131 to improve the light-extinction effect. In addition, the light-extinction structures 131 can also be ensured to be easy to be manufactured within the distance, for example, laser engraving is one of optional methods.

It should be noted that besides a case that the light-extinction effect can be improved in the radial direction of the light-transmission region 11, the light-extinction effect can also be improved in a circumferential direction around the light-transmission region 11. For example, a light-extinction structure 131 adjacent to the light-transmission region 11 is smaller than a light-extinction structure 131 away from the light-transmission region 11 for each two adjacent light-extinction structures 131 in each light-extinction group 13, to define an included angle of 1°˜30° between adjacent light-extinction groups, such as 1°, 15°, 30°, etc.

The direction illustrated in FIG. 2 is taken as the reference. In one light-extinction group 13, a connection line of leftmost endpoints of all the light-extinction structures 131 constitutes a left edge line of the light-extinction group 13, and a connection line of rightmost endpoints of all the light-extinction structures 131 constitutes a right edge line of the light-extinction group 13. Therefore, in two adjacent light-extinction groups 13, included angle B1 is defined between a right edge line of a left light-extinction group 13 and a left edge line of a right light-extinction group 13, where included angle B1 is an included angle defined between adjacent light-extinction groups 13.

After included angle B1 between adjacent light-extinction groups 13 is limited to be within 1°˜30°, distances between adjacent light-extinction groups 13 can be avoided to be excessive, which provides a guarantee for the light-extinction effect. In addition, since fixed included angle B1 is defined between adjacent light-extinction groups 13, distances between adjacent light-extinction groups 13 will change linearly, such that the light-extinction effect becomes more uniform.

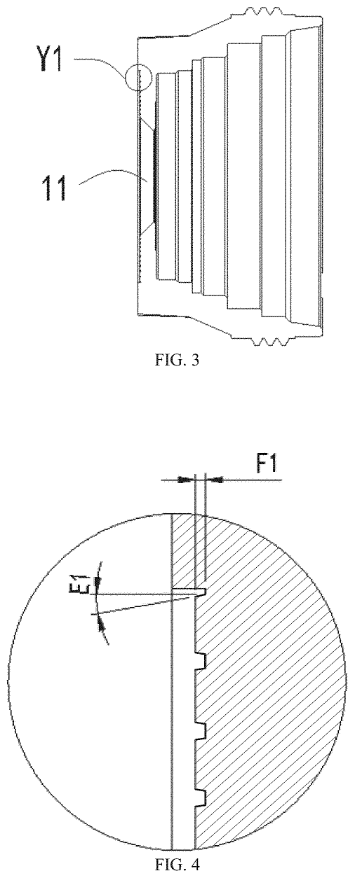

Similarly, in this case, in the same light-extinction group 13, included angle A1 will be defined between a left edge line of the light-extinction group 13 and a right edge line of the light-extinction group 13, included angle A1 is an included angle between two sides of the light-extinction group 13, and the included angle between the two sides of the light-extinction group 13 can be preferably set to be within 1°˜20°, such as 1°, 10°, 20°, etc. In addition, arrangement illustrated in FIG. 3 and FIG. 4 can also be adopted, and a height of the light-extinction structure 131 can be set as F1, where F1=0.005 mm˜0.1 mm. A draft angle can be defined between a side surface of the light-extinction structure 131 and the light-extinction surface 12, and the daft angle of the light-extinction structure 131 is E1, where E1=0°˜20°, so as to facilitate processing and manufacturing of the light-extinction structure. It can be understood that the draft angle defined between the side surface of the light-extinction structure 131 and the light-extinction surface 12 means a draft angle defined between the side surface of the light-extinction structure 131 and the normal of the light-extinction surface 12, i.e., an angle of the side surface of the light-extinction structure 131, with respect to the direction of pull.

In addition, in order to define an included angle of 1°˜20° between adjacent light-extinction groups 13, the direction illustrated in FIG. 2 is taken as a reference, in the same light-extinction group 13, a left-to-right width of the upper light-extinction structure 131 needs to be greater than a left-to-right width of the lower light-extinction structure 131. This arrangement can ensure that distances between adjacent light-extinction groups 13 are small enough, in other words, a reflection area is reduced, and the light-extinction effect is improved.

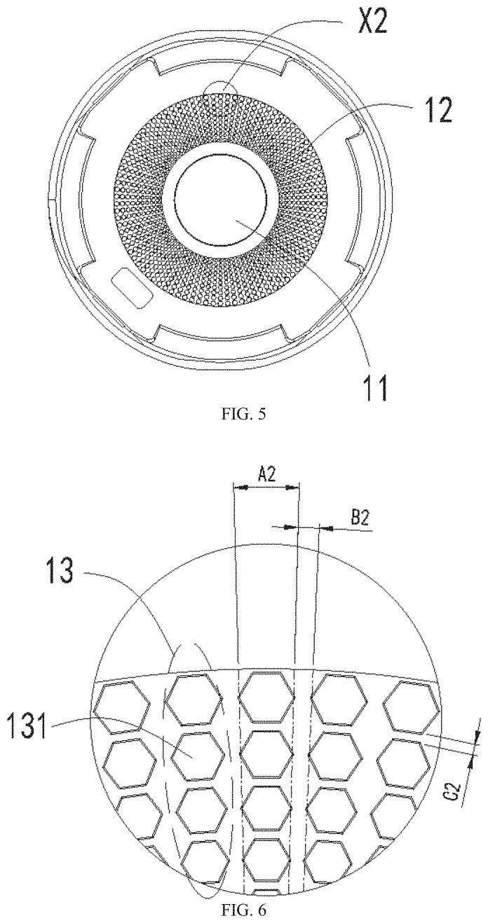

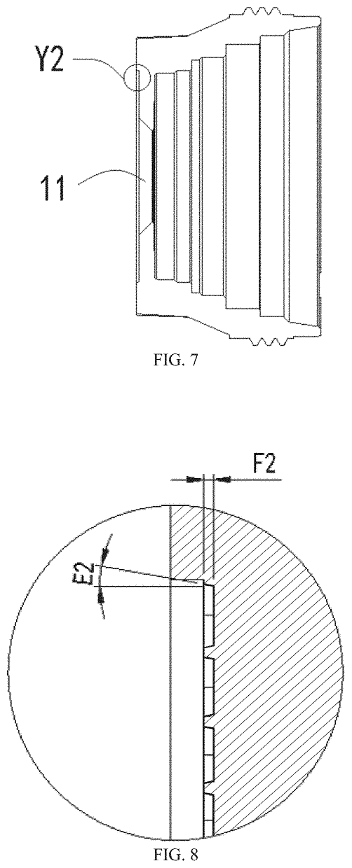

A second implementation of a low-reflection structure of the present disclosure is illustrated in FIG. 5 to FIG. 8, which is substantially consistent with the first implementation of the low-reflection structure of the present disclosure, with a difference that the light-extinction structures 131 are grooves depressively defined from the light-extinction surface 12, in other words, each light-extinction structure 131 is a hexagonal groove in this case.

In this case, in the same light-extinction group 13, the included angle between two sides of the light-extinction group 13 can be set as A2, where A2=1°˜20°, and the distance between adjacent light-extinction structures 131 can be set as C2, where C2=0.005 mm˜0.1 mm. Between adjacent light-extinction groups 13, included angle B2 can be defined between adjacent light-extinction groups 13, where B2=1°˜30°. In addition, a depth of the light-extinction structure 131 can be set as F2, where F2=0.005 mm˜0.1 mm, and the draft angle of the light-extinction structure 131 can be set as E2, where E2=0°˜20°.

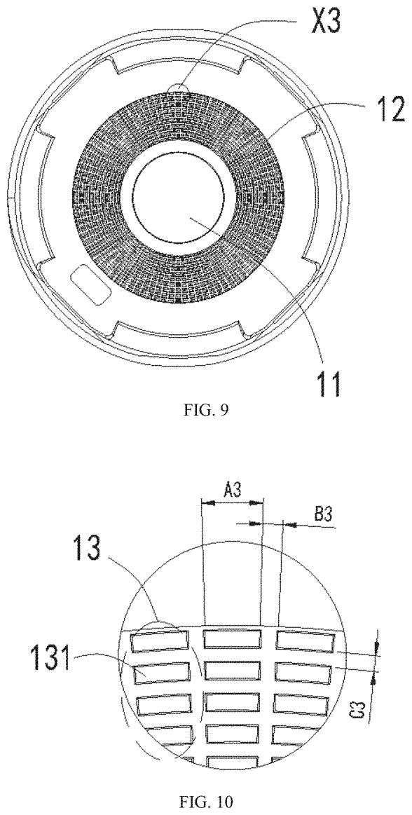

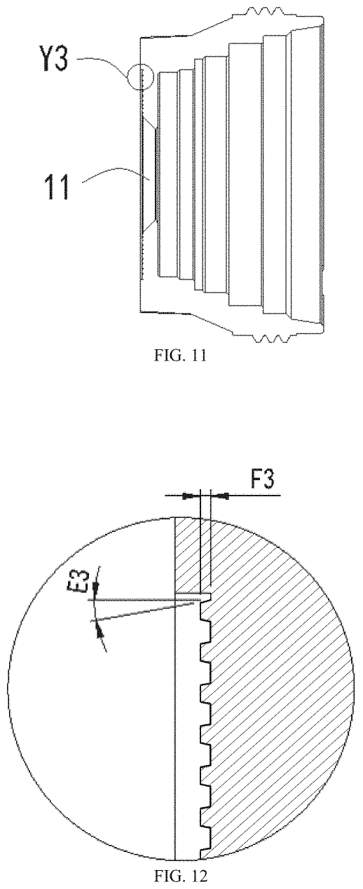

A third implementation of a low-reflection structure of the present disclosure is illustrated in FIG. 9 to FIG. 12, which is substantially consistent with the first implementation of the low-reflection structure of the present disclosure, with a difference that the light-extinction structures 131 are bosses protrudingly formed from the light-extinction surface 12, in other words, each light-extinction structure 131 is a sectorial boss in this case.

In this case, in the same light-extinction group 13, the included angle between two sides of the light-extinction group 13 can be defined as A3, where A3=1°˜30°, and the distance between adjacent light-extinction structures 131 can be set as C3, where C3=0.005 mm˜0.1 mm. Between adjacent light-extinction groups 13, included angle B3 can be defined between adjacent light-extinction groups 13, where B3=1°˜20°. In addition, the height of the light-extinction structure 131 can be set as F3, where F3=0.005 mm˜0.1 mm, and the draft angle of the light-extinction structure 131 can be set as E3, where E3=0°˜20°.

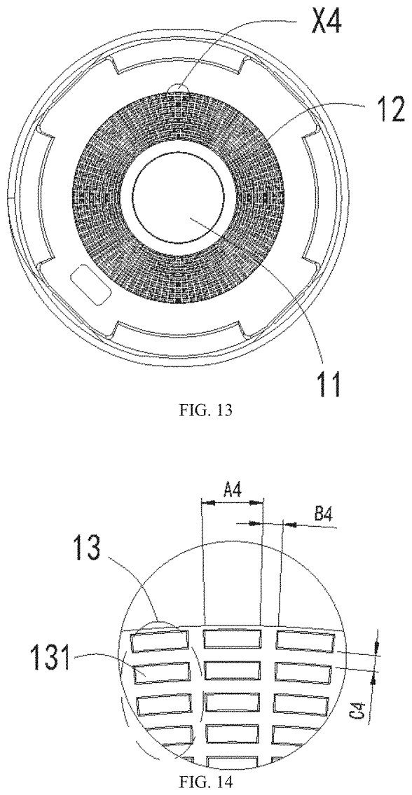

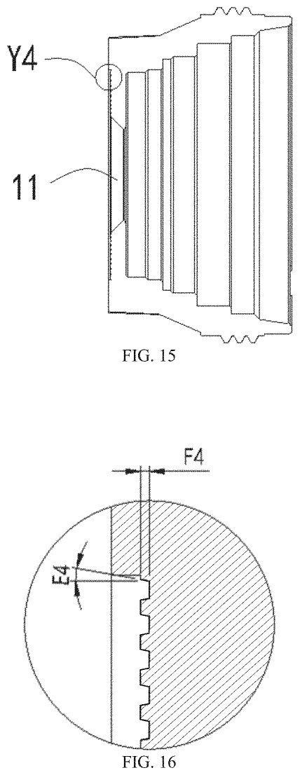

A fourth implementation of a low-reflection structure of the present disclosure is illustrated in FIG. 13 to FIG. 16, which is substantially consistent with the third implementation of the low-reflection structure of the present disclosure, with a difference that the light-extinction structures 131 are grooves depressively defined from the light-extinction surface 12, in other words, each light-extinction structure 131 is a sectorial groove in this case.

In this case, in the same light-extinction group 13, the included angle between two sides of the light-extinction group 13 can be defined as A4, where A4=1°˜30°, and the distance between adjacent light-extinction structures 131 can be set as C4, where C4=0.005 mm˜0.1 mm. Between adjacent light-extinction groups 13, included angle B4 can be defined between adjacent light-extinction groups 13, where B4=1°˜20°. In addition, the depth of the light-extinction structure 131 can be set as F4, where F4=0.005 mm˜0.1 mm, and the draft angle of the light-extinction structure 131 can be set as E4, where E4=0°˜20°.

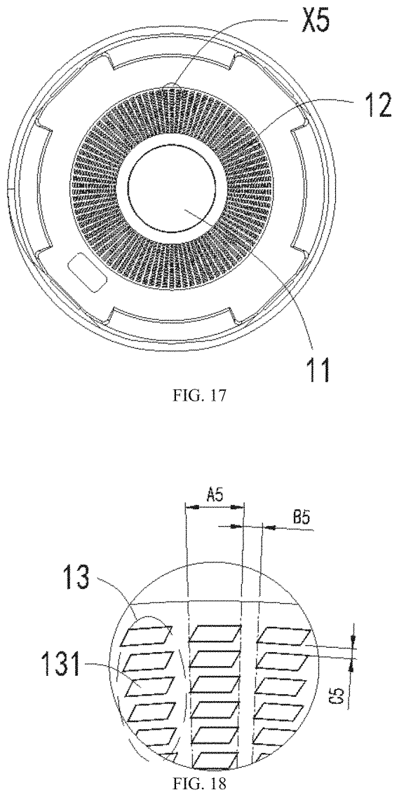

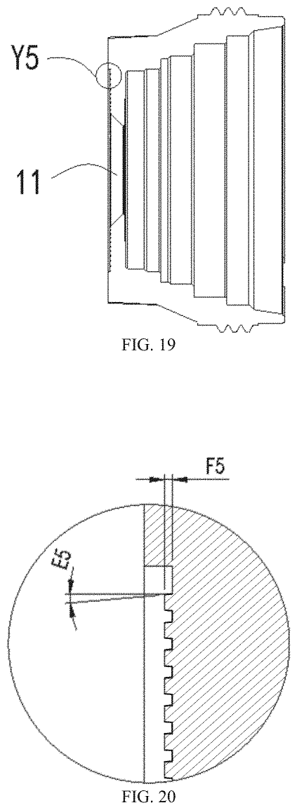

A fifth implementation of a low-reflection structure of the present disclosure is illustrated in FIG. 17 to FIG. 20, which is substantially consistent with the first implementation of the low-reflection structure of the present disclosure, with a difference that the light-extinction structures 131 are bosses protrudingly formed from the light-extinction surface 12, in other words, each light-extinction structure 131 is a parallelogram boss in this case.

In this case, in the same light-extinction group 13, the included angle between two sides of the light-extinction group 13 can be defined as A5, where A5=1°˜30°, and the distance between adjacent light-extinction structures 131 can be set as C5, where C5=0.005 mm˜0.1 mm. Between adjacent light-extinction groups 13, included angle B5 can be defined between adjacent light-extinction groups 13, where B5=1°˜20°. In addition, the height of the light-extinction structure 131 can be set as F5, where F5=0.005 mm˜0.1 mm, and the draft angle of the light-extinction structure 131 can be set as E5, where E5=0°˜20°.

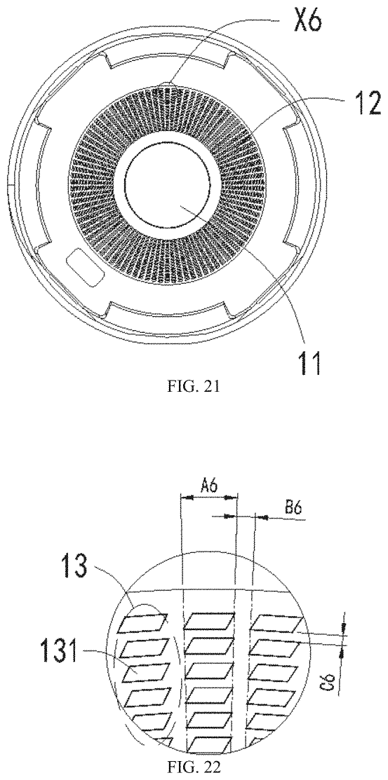

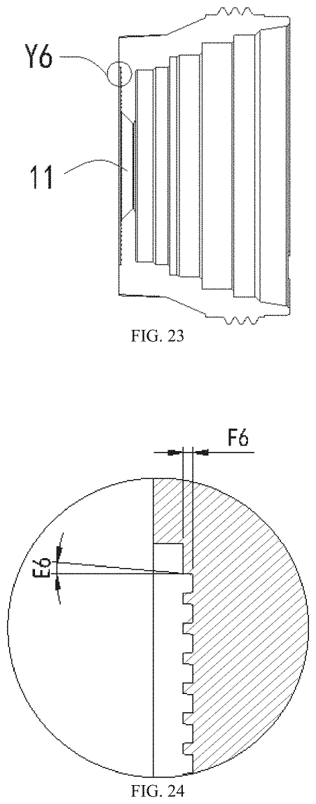

A sixth implementation of a low-reflection structure of the present disclosure is illustrated in FIG. 21 to FIG. 24, which is substantially consistent with the fifth implementation of the low-reflection structure of the present disclosure, with a difference that the light-extinction structures 131 are grooves depressively defined from the light-extinction surface 12, in other words, each light-extinction structure 131 is a parallelogram groove in this case.

In this case, in the same light-extinction group 13, the included angle between two sides of the light-extinction group 13 can be defined as A6, where A6=1°˜30°, and the distance between adjacent light-extinction structures 131 can be set as C6, where C6=0.005 mm˜0.1 mm. Between adjacent light-extinction groups 13, included angle B6 can be defined between adjacent light-extinction groups 13, where B6=1°˜20°. In addition, the depth of the light-extinction structure 131 can be set as F6, where F6=0.005 mm˜0.1 mm, and the draft angle of the light-extinction structure 131 can be set as E6, where E6=0°˜20°.

It should be noted that since shapes of all the light-extinction structures 131 are basically consistent, after the light-extinction structures 131 are regularly arranged, a relatively large distance is easily defined between adjacent light-extinction structures 131, and a problem of relatively large distance is particularly obvious especially in the circumferential direction around the light-transmission region 11.

For example, reference can be made to FIG. 25, if the light-extinction structures 131 are set as upward-pointing triangles, in the circumferential direction of the light-transmission region 11, gaps between lower sides of the light-extinction structures 131 are relatively small, and gaps between upper sides of the light-extinction structures 131 are relatively large, such that the light-extinction effect of the upper sides of the light-extinction structures 131 is affected.

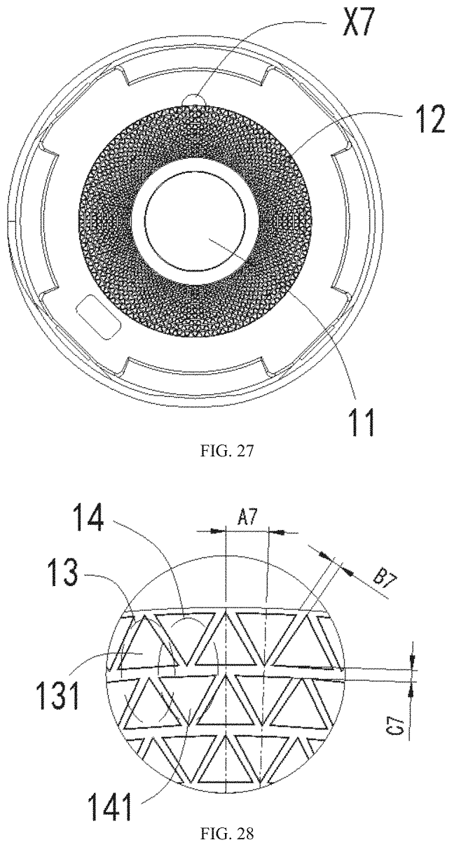

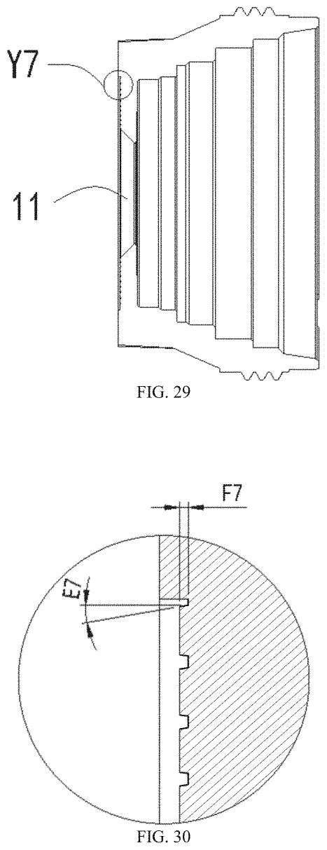

Therefore, in order to solve this problem, reference can be made to FIG. 27 to FIG. 30, multiple intermediate light-extinction groups 14 are further disposed at the light-extinction surface 12, and an intermediate light-extinction group 14 is disposed between adjacent light-extinction groups 13. Each intermediate light-extinction group 14 has multiple intermediate light-extinction structures 141, and the multiple intermediate light-extinction structures 141 of each intermediate light-extinction group 14 are all arranged in the radial direction of the light-transmission region 11.

For intermediate light-extinction groups 14, they are also arranged in the radial direction of the light-transmission region 11, which is similar to arrangement of the light-extinction groups 13. For intermediate light-extinction structures 141, in the circumferential direction around the light-transmission region 11, the intermediate light-extinction structures 141 will be arranged between adjacent light-extinction structures 131, light can be reflected between the light-extinction structures 131 and the intermediate light-extinction structures 141, in other words, the intermediate light-extinction structures 141 can reduce a reflection area and increase reflection times to provide an important guarantee for improving the light-extinction effect.

Specifically, reference can be made to FIG. 27 to FIG. 30, and specific arrangement of the intermediate light-extinction groups 14 can be referred to a seventh implementation of the low-reflection structure of the present disclosure. In this case, the light-extinction structures 131 and the intermediate light-extinction structures 141 each are triangular bosses, however, the light-extinction structures 131 are upward-pointing triangular bosses, in other words, pointing away from the geometric center of the light-transmission region 11, while the intermediate light-extinction structures 141 are downward-pointing triangular bosses, in other words, pointing to the geometric center of the light-transmission region 11, such that the intermediate light-extinction groups 14 will fill gaps between adjacent light-extinction groups 13, thus greatly improving the light-extinction effect.

In this case, included angle A7 is defined between a center axial direction of the light-extinction group 13 and a center axial direction of the intermediate light-extinction group 14, where A7=1°˜20°. In the circumferential direction around the light-transmission region 11, a distance between the light-extinction structure 131 and the intermediate light-extinction structure 141 is B7, where B7=0.005 mm˜0.1 mm. In the same light-extinction group 13, a distance between adjacent light-extinction structures 131 is C7, where C7=0.005 mm˜0.1 mm. Similarly, in the same intermediate light-extinction group 14, a distance between adjacent intermediate light-extinction structures 141 is also C7, where C7=0.005 mm˜0.1 mm. In addition, a height of the light-extinction structure 131 and a height of the intermediate light-extinction structure 141 can also be set as F7, where F7=0.005 mm˜0.1 mm. A draft angle is defined between a side surface of the light-extinction structure 131 and the light-extinction surface 12, and the draft angle of the light-extinction structure 131 is E7. A draft angle is defined between a side surface of the intermediate light-extinction structure 141 and the light-extinction surface 12, and the draft angle of the intermediate light-extinction structure 141 is also E7, where E7=0°˜20°.

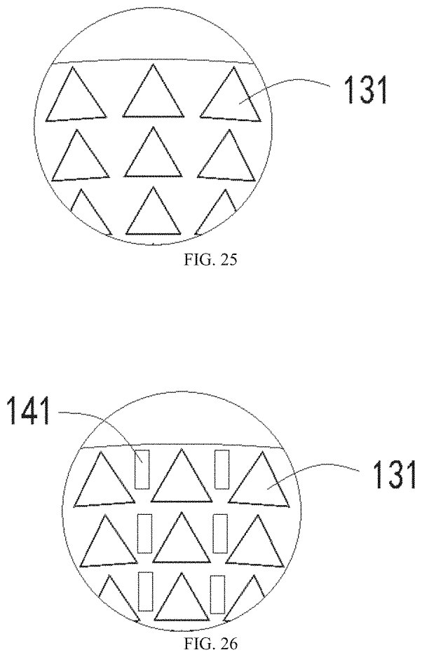

Of course, the above intermediate light-extinction structures 141 are set as the downward-pointing triangular bosses, which aims to strengthen shape matching with the light-extinction structures 131 to minimize a reflection area and maximize reflection times. Therefore, the intermediate light-extinction structures 141 may also be substantially set as other shapes, in this case, the reflection area can also be reduced, and the reflection times can also be increased. For example, reference can be made to FIG. 26, in this case, the light-extinction structures 131 are the upward-pointing triangular bosses, and the intermediate light-extinction structures 141 are rectangular bosses extending upward or downward. Although a reduced reflection area and increased reflection times by this structure are inferior to those by reverse arrangement of two triangles, obviously, this structure equally enables to reduce a distance between upper sides of two upward-pointing triangles, reduce the reflection area, and increase the reflection times.

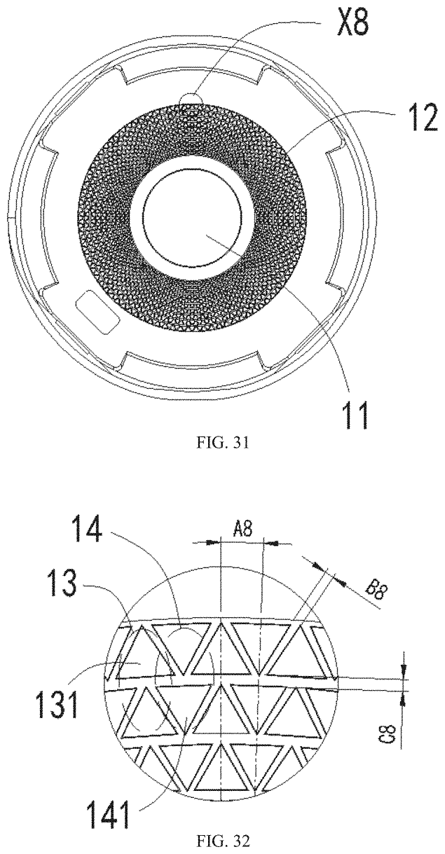

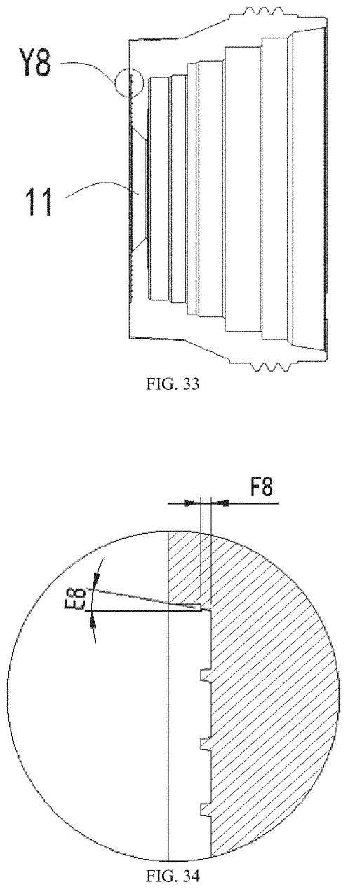

An eighth implementation of a low-reflection structure of the present disclosure is illustrated in FIG. 31 to FIG. 34, which is substantially consistent with the seventh implementation of the low-reflection structure of the present disclosure, with a difference that the in this case the light-extinction structures 131 and the intermediate light-extinction structures 141 each are grooves depressively defined from the light-extinction surface 12, the light-extinction structures 131 are upward-pointing triangular grooves, and the intermediate light-extinction structures 141 are downward-pointing triangular grooves.

In this case, included angle A8 is defined between a center axial direction of the light-extinction group 13 and a center axial direction of the intermediate light-extinction group 14, where A8=1°˜20°. In the circumferential direction around the light-transmission region 11, a distance between the light-extinction structure 131 and the intermediate light-extinction structure 141 is B8, where B8=0.005 mm˜0.1 mm. In the same light-extinction group 13, a distance between adjacent light-extinction structures 131 is C8, where C8=0.005 mm˜0.1 mm. Similarly, in the same intermediate light-extinction group 14, a distance between adjacent intermediate light-extinction structures 141 is also C8, where C8=0.005 mm˜0.1 mm. In addition, a depth of the light-extinction structure 131 and a depth of the intermediate light-extinction structure 141 can also be set as F8, where F8=0.005 mm˜0.1 mm, and a draft angle of the light-extinction structure 131 and a draft angle of the intermediate light-extinction structure 141 can be defined as E8, where E8=0°˜20°.

It can be seen from the seventh implementation and the eighth implementation of the low-reflection structure that, in the circumferential direction around the light-transmission region 11 of two implementations, the light-extinction structures 131 and the intermediate light-extinction structure 141 are arranged in alternation. In other words, in this case, it is only necessary to ensure that the intermediate light-extinction structure 141 is arranged between any adjacent light-extinction structures 131 in the circumferential diction around the light-transmission region 11, that is, a shape and a quantity of the intermediate light-extinction structure 141 between adjacent light-extinction structures 131 are not limited.

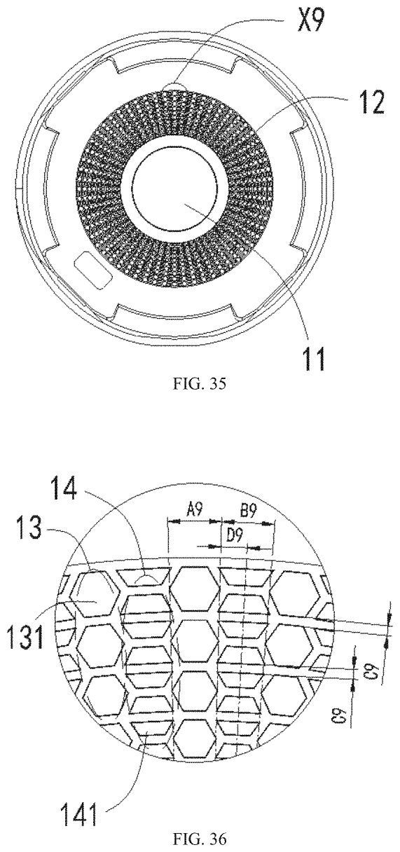

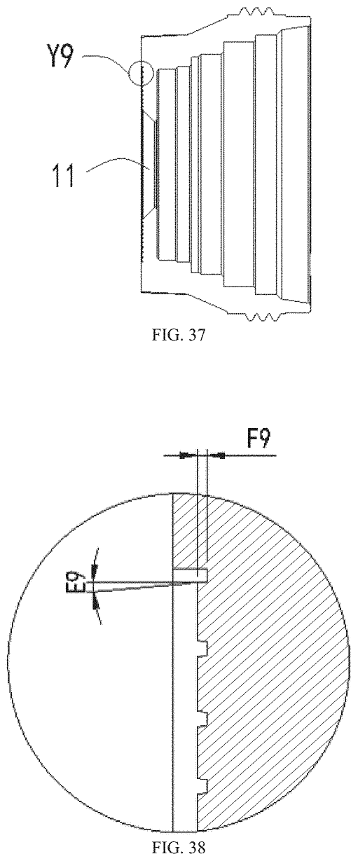

Specifically, in other words, it can also be defined that in the circumferential direction around the light-transmission region 11, at least two intermediate light-extinction structures 141 are arranged between two adjacent light-extinction structures 131, which can also realize a purpose of improving the light-extinction effect. For example, a ninth implementation of a low-reflection structure of the present disclosure can adopt a solution illustrated in FIG. 35 to FIG. 38, in this case, the light-extinction structures 131 are hexagonal bosses, and the intermediate light-extinction structures 141 are trapezoidal bosses. In addition, two trapezoidal bosses are arranged between any two hexagonal bosses in the circumferential direction around the light-transmission region 11. Trapezoidal bosses adjacent to upper sides of the hexagonal bosses are arranged with short edges facing down, and trapezoidal bosses adjacent to lower sides of the hexagonal bosses are arranged with short edges facing up; in other words, trapezoidal bosses adjacent to upper sides of the hexagonal bosses are arranged with short edges facing the geometric center of the light-transmission region 11, and trapezoidal bosses adjacent to lower sides of the hexagonal bosses are arranged with short edges facing away from the geometric center of the light-transmission region 11. In this way, shapes of the hexagonal bosses match with shapes of the trapezoidal bosses, so as to better reduce a reflection area and increase reflection times, and further optimize the light-extinction effect.

In this case, in the same light-extinction group 13, an included angle between two sides of the light-extinction group 13 can be defined as A9, where A9=1°˜30°, and a distance between adjacent light-extinction structures 131 can be set as C9, where C9=0.005 mm˜0.1 mm. In the circumferential direction around the light-transmission region 11, a distance between adjacent light-extinction structures 131 is B9, where B9=0.005 mm˜0.1 mm, and a distance between an edge of the light-extinction structure 131 and a center of the intermediate light-extinction structure 141 is D9, where D9=0.0025˜0.05 mm. In the same intermediate light-extinction group 14, a distance between adjacent intermediate light-extinction structures 141 is also C9, where C9=0.005 mm˜0.1 mm. In addition, a height of the light-extinction structure 131 and a height of the intermediate light-extinction structure 141 can also be set as F9, where F9=0.005 mm˜0.1 mm, and a draft angle of the light-extinction structure 131 and a draft angle of the intermediate light-extinction structure 141 can be defined as E9, where E9=0°˜20°.

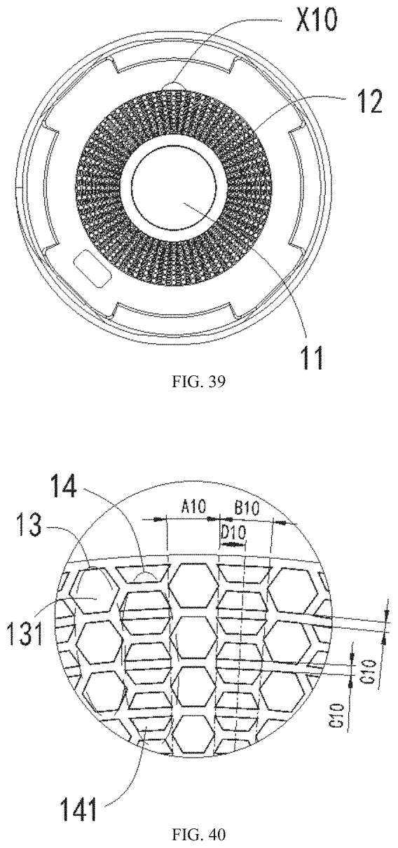

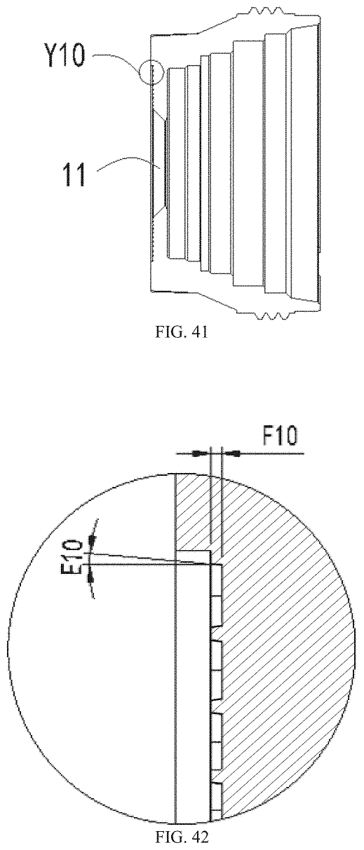

A tenth implementation of a low-reflection structure of the present disclosure is illustrated in FIG. 39 to FIG. 42, which is substantially consistent with the ninth implementation of the low-reflection structure of the present disclosure, with a difference that the in this case the light-extinction structures 131 and the intermediate light-extinction structures 141 each are grooves depressively defined from the light-extinction surface 12, the light-extinction structures 131 are hexagonal grooves, and the intermediate light-extinction structures 141 are trapezoidal grooves.

In this case, in the same light-extinction group 13, an included angle between two sides of the light-extinction group 13 can be defined as A10, where A10=1°˜30°, and a distance between adjacent light-extinction structures 131 can be set as C10, where C10=0.005 mm˜0.1 mm. In the circumferential direction around the light-transmission region 11, a distance between adjacent light-extinction structures 131 is B10, where B10=0.005 mm˜0.1 mm, and a distance between an edge of the light-extinction structure 131 and a center of the intermediate light-extinction structure 141 is D10, where D10=0.0025˜0.05 mm. In the same intermediate light-extinction group 14, a distance between adjacent intermediate light-extinction structures 141 is also C10, where C10=0.005 mm˜0.1 mm. In addition, a depth of the light-extinction structure 131 and a depth of the intermediate light-extinction structure 141 can also be set as F10, where F10=0.005 mm˜0.1 mm, and a draft angle of the light-extinction structure 131 and a draft angle of the intermediate light-extinction structure 141 can be defined as E10, where E10=0°˜20°.

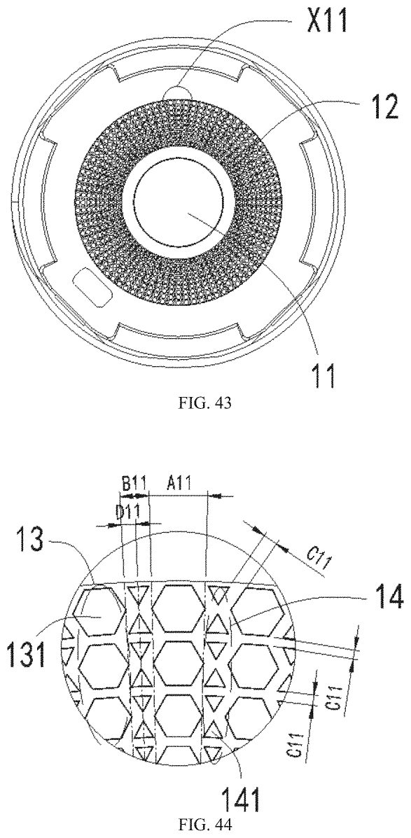

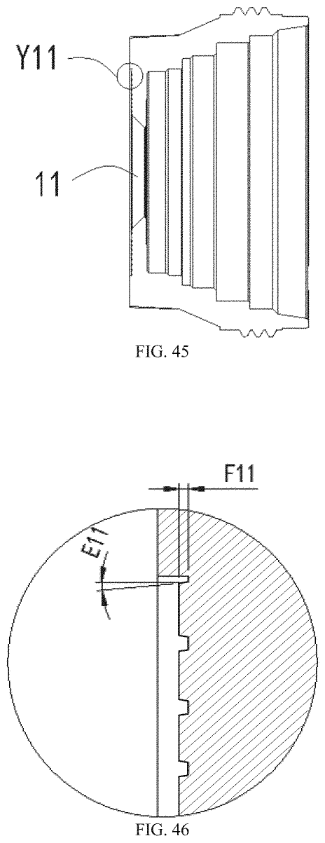

An eleventh implementation of a low-reflection structure of the present disclosure is illustrated in FIG. 43 to FIG. 46, which is substantially consistent with the ninth implementation of the low-reflection structure of the present disclosure, with a difference that the in this case the light-extinction structures 131 and the intermediate light-extinction structures 141 each are bosses protrudingly formed from the light-extinction surface 12, the light-extinction structures 131 are hexagonal bosses, and the intermediate light-extinction structures 141 includes upward-pointing triangular bosses and downward-pointing triangular bosses, the upward-pointing triangular bosses are arranged adjacent to lower sides of the hexagonal bosses, and the downward-pointing triangular bosses are arranged adjacent to upper sides of the hexagonal bosses.

In this case, in the same light-extinction group 13, an included angle between two sides of the light-extinction group 13 can be defined as A11, where A11=1°˜30°, and a distance between adjacent light-extinction structures 131 can be set as C11, where C11=0.005 mm˜0.1 mm. In the circumferential direction around the light-transmission region 11, an included angle between adjacent light-extinction groups 13 is B11, where B11=1°˜20°, and an included angle between an edge of light-extinction structure 131 and a central axis of the intermediate light-extinction structure 141 is D11, where D11=1°˜10°. In the same intermediate light-extinction group 14, a distance between adjacent intermediate light-extinction structures 141 is also C11, where C11=0.005 mm˜0.1 mm. In addition, a height of the light-extinction structure 131 and a height of the intermediate light-extinction structure 141 can also be set as F11, where F11=0.005 mm˜0.1 mm, a draft angle of the light-extinction structure 131 and a draft angle of the intermediate light-extinction structure 141 can be defined as E11, where E11=0°˜20°, and a distance between the light-extinction structure 131 and the intermediate light-extinction structure 141 can be set as C11, where C11=0.005 mm˜0.1 mm.

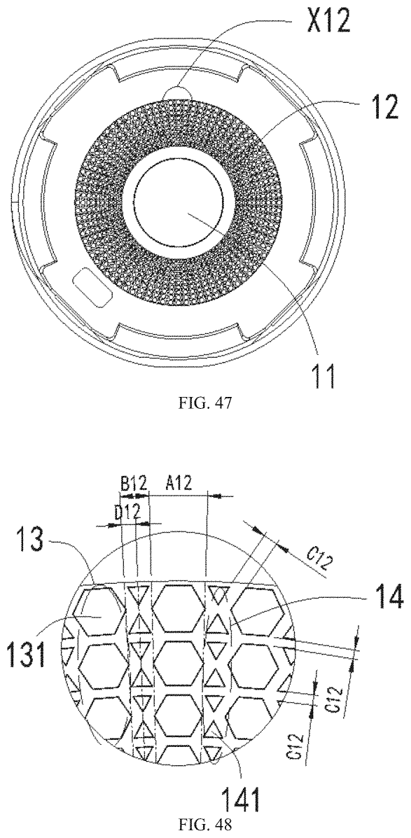

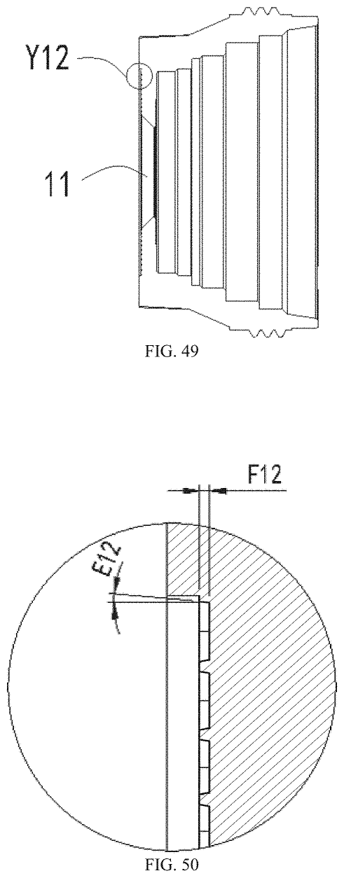

A twelfth implementation of a low-reflection structure of the present disclosure is illustrated in FIG. 47 to FIG. 50, which is substantially consistent with the eleventh implementation of the low-reflection structure of the present disclosure, with a difference that in this case the light-extinction structures 131 and the intermediate light-extinction structures 141 each are grooves depressively defined from the light-extinction surface 12, the light-extinction structures 131 are hexagonal grooves, and the intermediate light-extinction structures 141 include upward-pointing triangular grooves and downward-pointing triangular grooves, the upward-pointing triangular grooves are arranged adjacent to lower sides of the hexagonal grooves, and the downward-pointing triangular grooves are arranged adjacent to upper sides of the hexagonal grooves.

In this case, in the same light-extinction group 13, an included angle between two sides of the light-extinction group 13 can be defined as A12, where A12=1°˜30°, and a distance between adjacent light-extinction structures 131 can be set as C12, where C12=0.005 mm˜0.1 mm. In the circumferential direction around the light-transmission region 11, an included angle between adjacent light-extinction groups 13 is B12, where B 12=1°˜20°, and an included angle between an edge of light-extinction structure 131 and a central axis of the intermediate light-extinction structure 141 is D12, where D12=1°˜10°. In the same intermediate light-extinction group 14, a distance between adjacent intermediate light-extinction structures 141 is also C12, where C12=0.005 mm˜0.1 mm. In addition, a depth of the light-extinction structure 131 and a depth of the intermediate light-extinction structure 141 can also be set as F12, where F12=0.005 mm˜0.1 mm, a draft angle of the light-extinction structure 131 and a draft angle of the intermediate light-extinction structure 141 can be defined as E12, where E12=0°˜20°, and a distance between the light-extinction structure 131 and the intermediate light-extinction structure 141 can be set as C12, where C12=0.005 mm˜0.1 mm.

It should be noted that after the intermediate light-extinction structures 141 are added, the intermediate light-extinction structures 141 can reduce gaps between adjacent light-extinction structures 13 in the circumferential direction around the light-transmission region 11 to improve the light-extinction effect. In order to further improve the light-extinction effect, the light-extinction structures 131 and the intermediate light-extinction structures 141 can also be arranged in alternation in the radial direction of the light-transmission region 11.

In other words, in the radial direction of the light-transmission region 11, the intermediate light-extinction structure 141 can be opposite to a gap region between two adjacent light-extinction structures 131, and the light-extinction structure 131 can be opposite to a gap region between two adjacent intermediate light-extinction structures 141, that is, a reflection area is reduced, reflection times are increased, and a phenomenon that light is direct in the gap region is prevented.

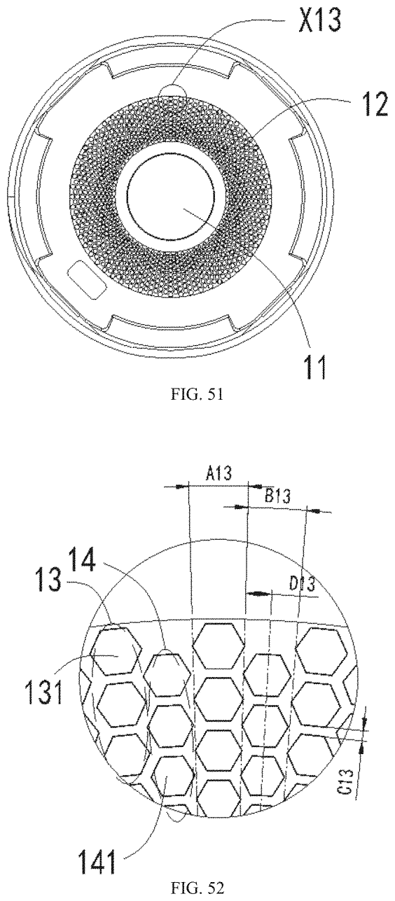

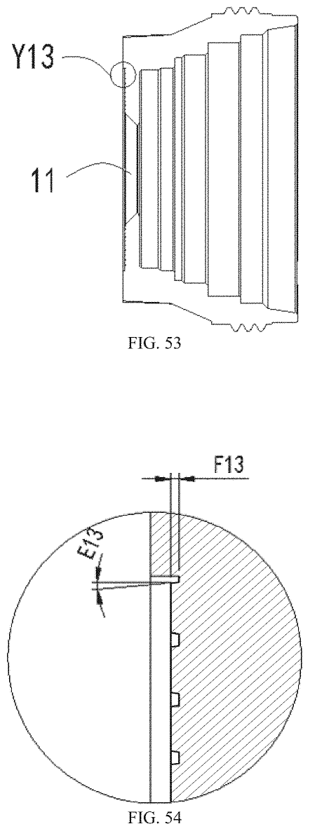

Specifically, a thirteenth implementation of a low-reflection structure of the present disclosure can be set as illustrated in FIG. 51 to FIG. 54, in this case, the light-extinction structures 131 and the intermediate light-extinction structures 141 each are bosses protrudingly formed from the light-extinction surface 12, and the light-extinction structures 131 and the intermediate light-extinction structures 141 each are hexagonal bosses. Since adjacent light-extinction structure 131 and the intermediate light-extinction structure 141 are arranged in alternation in a linear direction towards the light-transmission region 11, a left upper inclined surface of the intermediate light-extinction structure 141 will be parallel to a right lower inclined surface of the light-extinction structure 131, a right upper inclined surface of the intermediate light-extinction structure 141 will be parallel to a left lower inclined surface of the light-extinction structure 131, a left lower inclined surface of the intermediate light-extinction structure 141 will be parallel to a right upper inclined surface of the light-extinction structure 131, and a right lower inclined surface of the intermediate light-extinction structure 141 will be parallel to a left upper inclined surface of the light-extinction structure 131.

In this case, in the same light-extinction group 13, an included angle between two sides of the light-extinction group 13 can be defined as A13, where A13=1°˜30°, and a distance between adjacent light-extinction structures 131 can be set as C13, where C13=0.005 mm˜0.1 mm. In the circumferential direction around the light-transmission region 11, an included angle between adjacent light-extinction groups 13 is B13, where B13=1°˜20°, and an included angle between the light-extinction group 13 and a center of the intermediate light-extinction group 14 is D13, where D13=1°˜10°. In the same intermediate light-extinction group 14, a distance between adjacent intermediate light-extinction structures 141 is also C13, where C13=0.005 mm˜0.1 mm. In addition, a height of the light-extinction structure 131 and a height of the intermediate light-extinction structure 141 can also be set as F13, where F13=0.005 mm˜0.1 mm, and a draft angle of the light-extinction structure 131 and a draft angle of the intermediate light-extinction structure 141 can be defined as E13, where E13=0°˜20°.

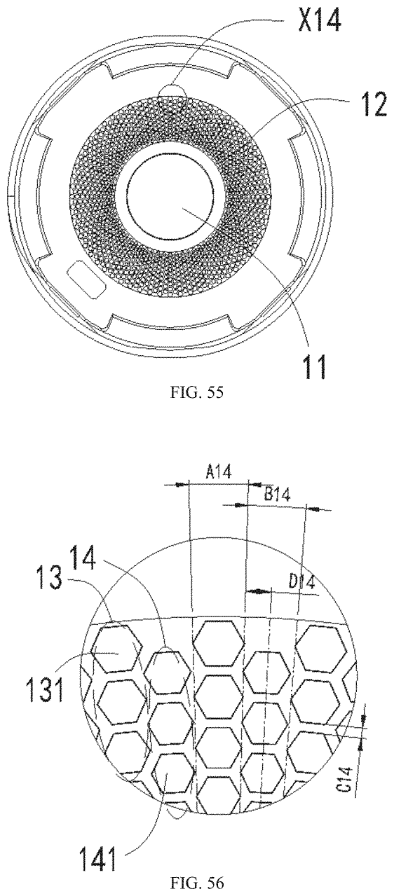

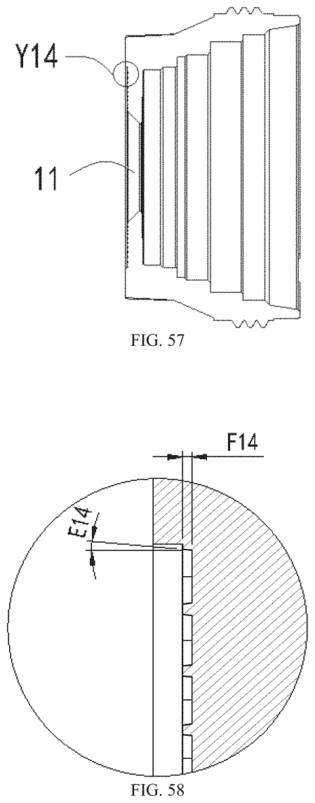

A fourteenth implementation of a low-reflection structure of the present disclosure is illustrated in FIG. 55 to FIG. 58, which is substantially consistent with the thirteenth implementation of the low-reflection structure of the present disclosure, with a difference that in this case the light-extinction structures 131 and the intermediate light-extinction structures 141 each are grooves depressively defined from the light-extinction surface 12, and the light-extinction structures 131 and the intermediate light-extinction structures 141 each are hexagonal grooves.

In this case, in the same light-extinction group 13, an included angle between two sides of the light-extinction group 13 can be defined as A14, where A14=1°˜30°, and a distance between adjacent light-extinction structures 131 can be set as C14, where C14=0.005 mm˜0.1 mm. In the circumferential direction around the light-transmission region 11, included angle B14 is defined between adjacent light-extinction groups 13, where B14=1°˜20°, and included angle D14 is defined between the light-extinction group 13 and a center of the intermediate light-extinction group 14, where D14=1°˜10°. In the same intermediate light-extinction group 14, a distance between adjacent intermediate light-extinction structures 141 is also C14, where C14=0.005 mm˜0.1 mm. In addition, a depth of the light-extinction structure 131 and a depth of the intermediate light-extinction structure 141 can be set as F14, where F14=0.005 mm˜0.1 mm, and a draft angle of the light-extinction structure 131 and a draft angle of the intermediate light-extinction structure 141 can be set as E14, where E14=0°˜20°.

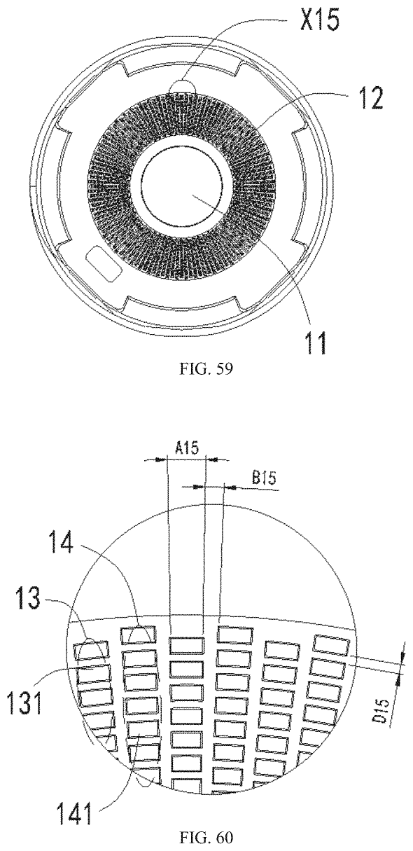

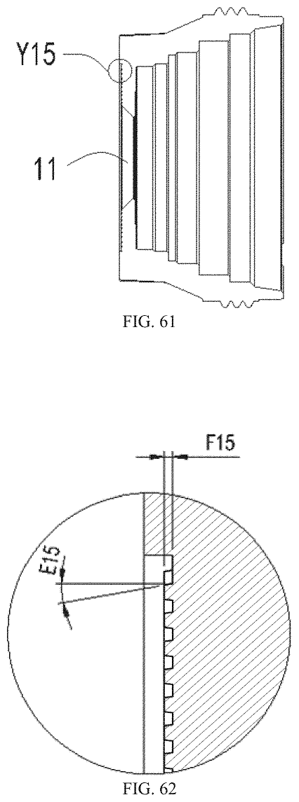

A fifteenth implementation of a low-reflection structure of the present disclosure is illustrated in FIG. 59 to FIG. 62, which is substantially consistent with the thirteenth implementation of the low-reflection structure of the present disclosure, with a difference that in this case the light-extinction structures 131 and the intermediate light-extinction structures 141 each are sectors protrudingly formed from the light-extinction surface 12, and the light-extinction structures 131 and the intermediate light-extinction structures 141 each are sectorial bosses. Since adjacent light-extinction structure 131 and the intermediate light-extinction structure 141 are arranged in alternation in the radial direction of the light-transmission region 11, a left side surface of the intermediate light-extinction structure 141 will be aligned with a gap region defined between two light-extinction structures 131 on the left side, and a right side surface of the intermediate light-extinction structure 141 will be aligned with a gap region defined between two light-extinction structures 131 on the right side.

In this case, in the same light-extinction group 13, an included angle between two sides of the light-extinction group 13 can be defined as A15, where A15=1°˜30°, and a distance between adjacent light-extinction structures 131 can be set as C15, where C15=0.005 mm˜0.1 mm. In the circumferential direction around the light-transmission region 11, included angle B15 is defined between the light-extinction group 13 and the intermediate light-extinction group 14, where B15=1°˜20°. In the same intermediate light-extinction group 14, a distance between adjacent intermediate light-extinction structures 141 is also C15, where C15=0.005 mm˜0.1 mm. In addition, a height of the light-extinction structure 131 and a height of the intermediate light-extinction structure 141 can be set as F15, where F15=0.005 mm˜0.1 mm, and a draft angle of the light-extinction structure 131 and a draft angle of the intermediate light-extinction structure 141 can be set as E15, where E15=0°˜20°.

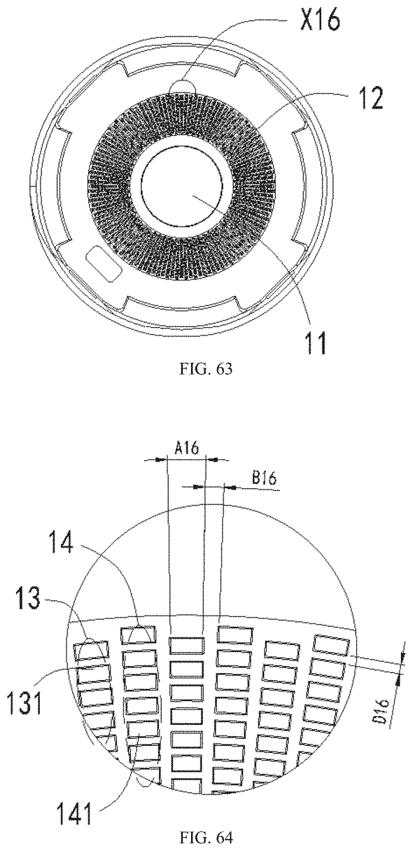

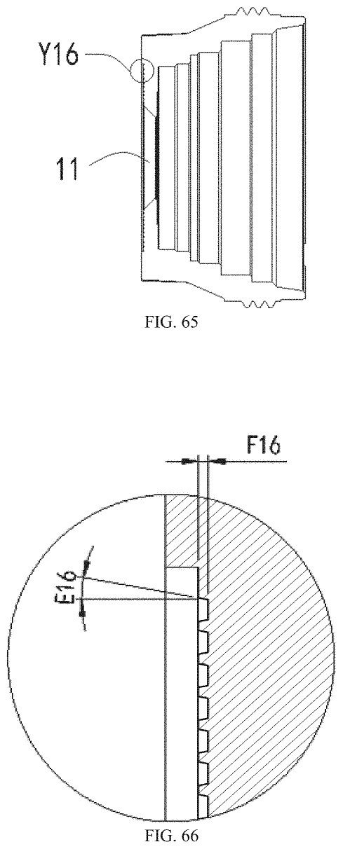

A sixteenth implementation of a low-reflection structure of the present disclosure is illustrated in FIG. 63 to FIG. 66, which is substantially consistent with the fifteenth implementation of the low-reflection structure of the present disclosure, with a difference that in this case the light-extinction structures 131 and the intermediate light-extinction structures 141 each are grooves depressively defined from the light-extinction surface 12, and the light-extinction structures 131 and the intermediate light-extinction structures 141 each are sectorial grooves.

In this case, in the same light-extinction group 13, an included angle between two sides of the light-extinction group 13 can be defined as A16, where A16=1°˜30°, and a distance between adjacent light-extinction structures 131 can be set as C16, where C16=0.005 mm˜0.1 mm. In the circumferential direction around the light-transmission region 11, included angle B 16 is defined between the light-extinction group 13 and the intermediate light-extinction group 14, where B16=1°˜20°. In the same intermediate light-extinction group 14, a distance between adjacent intermediate light-extinction structures 141 is also C16, where C16=0.005 mm˜0.1 mm. In addition, a depth of the light-extinction structure 131 and a depth of the intermediate light-extinction structure 141 can be set as F16, where F16=0.005 mm˜0.1 mm, and a draft angle of the light-extinction structure 131 and a draft angle of the intermediate light-extinction structure 141 can be set as E16, where E16=0°−20°.

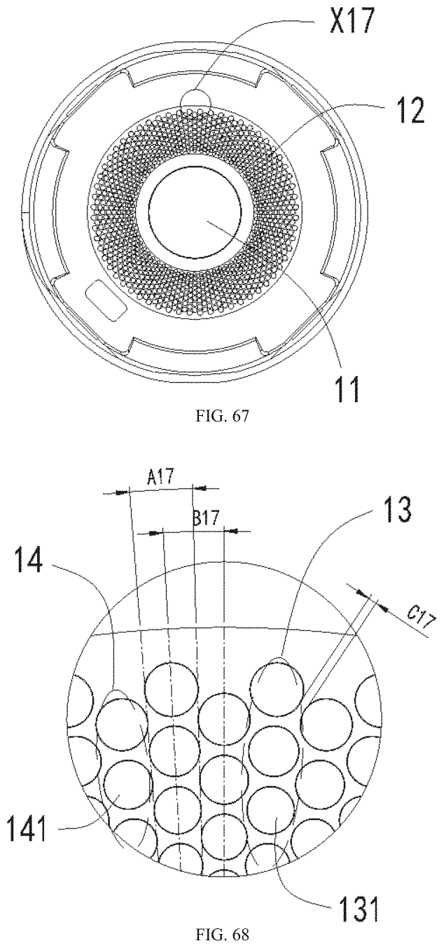

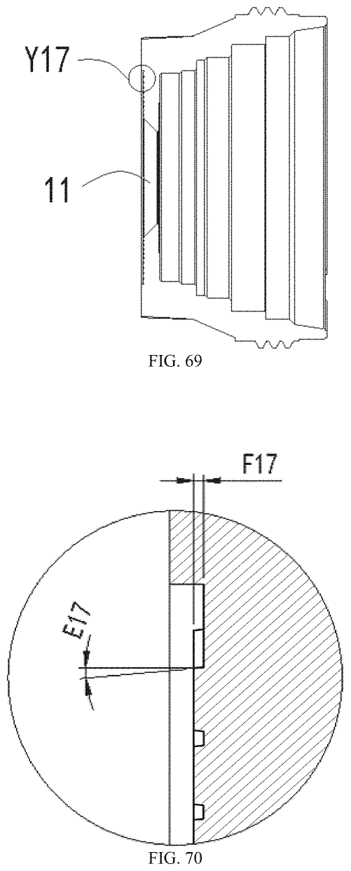

A seventeenth implementation of a low-reflection structure of the present disclosure is illustrated in FIG. 67 to FIG. 70, which is substantially consistent with the thirteenth implementation of the low-reflection structure of the present disclosure, with a difference that in this case the light-extinction structures 131 and the intermediate light-extinction structures 141 each are bosses protrudingly formed from the light-extinction surface 12, and the light-extinction structures 131 and the intermediate light-extinction structures 141 each are circular bosses.

In this case, in the same light-extinction group 13, an included angle between two sides of the light-extinction group 13 can be defined as A17, where A17=1°˜30°. In a circumferential direction, included angle B17 is defined between a center axial direction of the light-extinction group 13 and a center axial direction of the intermediate light-extinction group 14, where B17=2°˜20°. In addition, a height of the light-extinction structure 131 and a height of the intermediate light-extinction structure 141 can be set as F17, where F17=0.005 mm˜0.1 mm, a draft angle of the light-extinction structure 131 and a draft angle of the intermediate light-extinction structure 141 can be set as E17, where E17=0°˜20°, and a distance between the light-extinction structure 131 and the intermediate light-extinction structure 141 can be set as C17, where C17=0.005 mm˜0.1 mm.

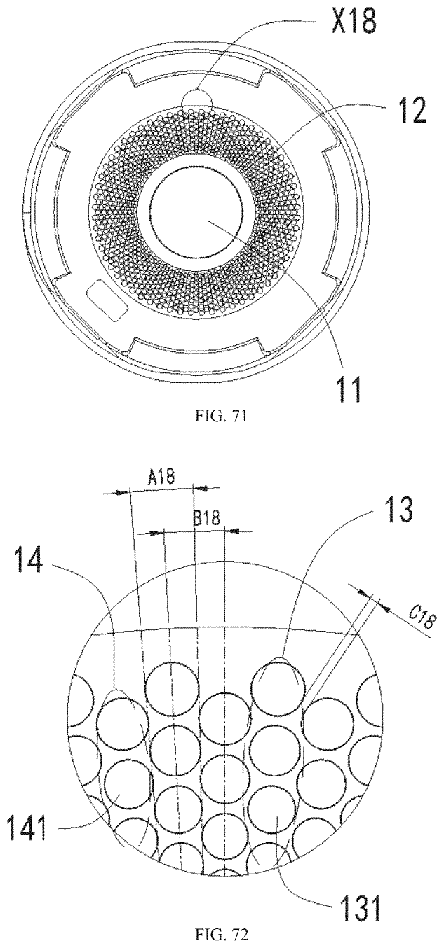

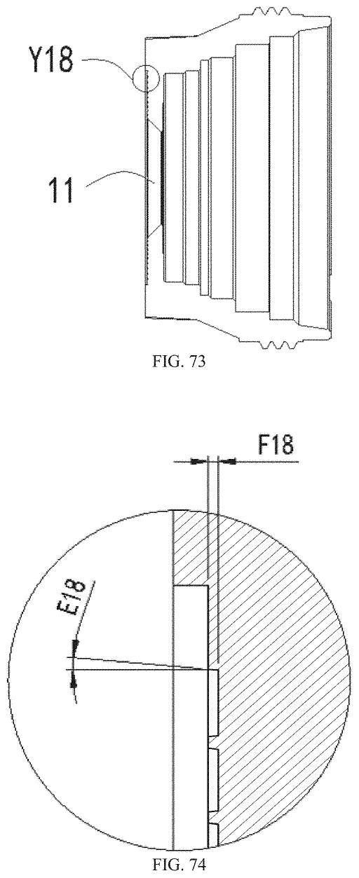

An eighteenth implementation of a low-reflection structure of the present disclosure is illustrated in FIG. 71 to FIG. 74, which is substantially consistent with the seventeenth implementation of the low-reflection structure of the present disclosure, with a difference that in this case the light-extinction structures 131 and the intermediate light-extinction structures 141 each are grooves depressively defined from the light-extinction surface 12, and the light-extinction structures 131 and the intermediate light-extinction structures 141 each are circular grooves.

In this case, in the same light-extinction group 13, an included angle between two sides of the light-extinction group 13 can be defined as A18, where A18=1°˜30°. In the circumferential direction around the light-transmission region 11, included angle B18 is defined between a center axial direction of the light-extinction group 13 and a center axial direction of the intermediate light-extinction group 14, where B18=2°˜20°. In addition, a depth of the light-extinction structure 131 and a depth of the intermediate light-extinction structure 141 can be set as F18, where F18=0.005 mm˜0.1 mm, a draft angle of the light-extinction structure 131 and a draft angle of the intermediate light-extinction structure 141 can be set as E18, where E18=0°˜20°, and a distance between the light-extinction structure 131 and the intermediate light-extinction structure 141 can be set as C18, where C18=0.005 mm˜0.1 mm.

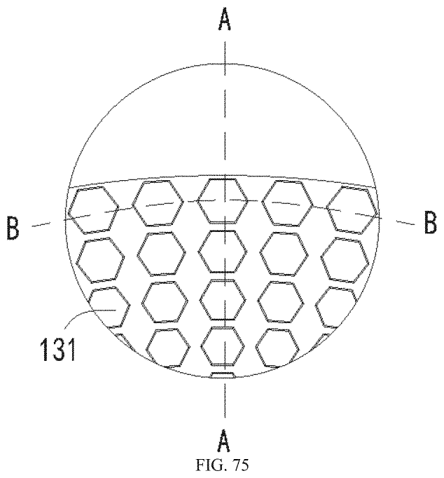

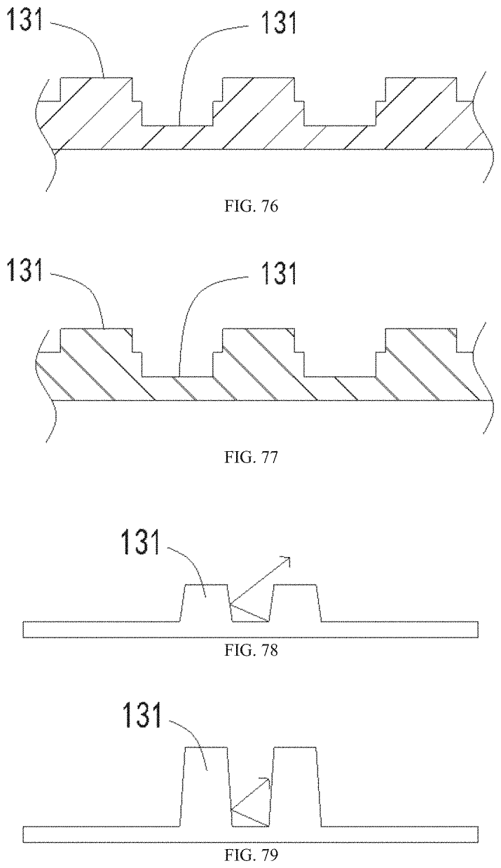

It should be noted that from the above implementations, the light-extinction structures 131 may be uniformly set as bosses or uniformly defined as grooves, but other arrangement methods may also be adopted in addition to the above two arrangement methods. Specifically, a nineteenth implementation of a low-reflection structure of the present disclosure is illustrated in FIG. 75 to FIG. 77, which is substantially consistent with the first implementation of the low-reflection structure of the present disclosure, with a difference that the light-extinction structures 131 include bosses protrudingly formed from the light-extinction surface 12 and grooves depressively defined from the light-extinction surface 12, and boss-shaped light-extinction structures 131 and groove-shaped light-extinction structures 131 are arranged in alternation in the radial direction of the light-transmission region 11.

In the same light-extinction group 13, the light-extinction structures 131 will be arranged in such a method that bosses and grooves are alternatively arranged. In this case, a height difference is formed between a top surface of a boss and a bottom surface of a groove, this is, a reflection area is reduced, and reflection times are increased, thus further improving the light-extinction effect.

On this basis, the boss-shaped light-extinction structures 131 and the groove-shaped light-extinction structures 131 can also be arranged in alternation in the circumferential direction around the light-transmission region 11, that is, in the radial direction of the light-transmission region 11 and in the same light-extinction group 13, height differences are formed which can improve the light-extinction effect; in the circumferential direction around the light-transmission region 11, height differences are also formed between adjacent light-extinction groups 13 which can improve the light-extinction effect.

In summary, when the light-extinction structure 131 is set as a boss, a height of the light-extinction structure 131 can be preferably set to be within 0.005 mm˜0.1 mm, which aims to ensure a sufficient gap depth. Reference can be made to FIG. 78, for example, since the light-extinction structure 131 has a relatively small height in this case, light is easy to be reflected to the outside, which cannot meet desired light-extinction requirements. However, in a solution illustrated in FIG. 79, since the light-extinction structure has a relatively large height, light will be reflected in alternation between adjacent light-extinction structures 131, that is, light is difficult to be reflected to the outside, thus realizing the light-extinction effect. In addition, within this parameter range, manufacturing of the light-extinction structure 131 can be completed by adopting an existing process. Similarly, the same is true for the intermediate light-extinction structures 141, which will not be described herein.

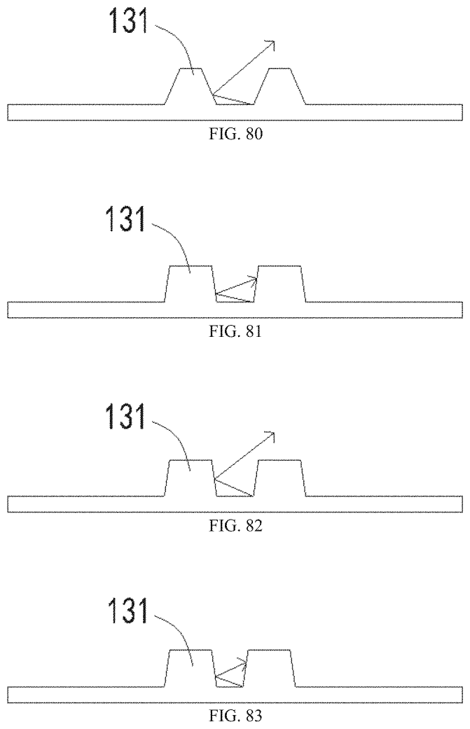

In addition, in this case a draft angle of the light-extinction structure 131 can be preferably set to be within 0°˜20°, which aims to prevent light from being reflected to the outside. Reference can be made to FIG. 80, for example, since the light-extinction structure 131 has a relatively large draft angle in this case, light is easy to be reflected to the outside, which cannot meet desired light-extinction requirements. However, in a solution illustrated in FIG. 81, since the light-extinction structure 131 has a relatively small draft angle, light will be reflected in alternation between adjacent light-extinction structures 131, that is, light is difficult to be reflected to the outside, thus realizing the light-extinction effect. Furthermore, within this parameter range, manufacturing of the light-extinction structure 131 can be completed by adopting an existing process. Similarly, the same is true for the intermediate light-extinction structures 141, which will not be described herein.

Furthermore, in this case a distance between light-extinction structures 131 can be preferably set to be within 0.005 mm˜0.1 mm, which also aims to prevent light from being reflected to the outside. Reference can be made to FIG. 82, for example, since a distance between adjacent light-extinction structures 131 is relatively large, light is easy to be reflected to the outside, which cannot meet desired light-extinction requirements. However, in a solution illustrated in FIG. 83, since a distance between adjacent light-extinction structures 131 is a relatively small in this case, light will be reflected in alternation between adjacent light-extinction structures 131, that is, light is difficult to be reflected to the outside, thus realizing the light-extinction effect. Moreover, within this parameter range, manufacturing of the light-extinction structure 131 can be completed by adopting an existing process. Similarly, the same is true for the intermediate light-extinction structures 141, which will not be described herein.

Moreover, in order to make arrangement of the light-extinction structures 131 more reasonable, the number of light-extinction structures 131 should be set to be within 5˜200 in each radial direction of the light-transmission region 11, in other words, the number of light-extinction structures 131 in each light-extinction group 13 is preferably set to be within as 5˜200. Of course, when the light-extinction structures 131 and the intermediate light-extinction structures 141 are set as grooves, the above effect can also be realized by setting with the above parameters, which will not be described herein.

It should also be noted that a shape of the light-extinction structure 131 is not particularly limited, but in order to improve the light-extinction effect, sufficient light-extinction structures 131 should be ensured to be disposed at the light-extinction surface 12, that is, on condition that process requirements can be realized, volumes of the light-extinction structures 131 should be reduced. For example, when the light-extinction structure 131 is circular, a diameter of the light-extinction structure 131 can be set to be within 0.01 mm˜0.3 mm. When the light-extinction structure 131 is non-circular, the light-extinction structure 131 can be set to have multiple side edges, and the length of a shortest side edge of the light-extinction structure is within 0.01 mm˜0.3 mm. Within this parameter range, arrangement of the light-extinction structure 131 can be ensured to be optimized.

Similarly, the same is true for the intermediate light-extinction structures 141. For example, when the intermediate light-extinction structure 141 is circular, a diameter of the intermediate light-extinction structure 141 can be set to be within 0.01 mm˜0.3 mm; when the intermediate light-extinction structure 141 is non-circular, a diameter of the intermediate light-extinction structure can be set to be within 0.01 mm˜0.3 mm. When the intermediate light-extinction structure 141 is non-circular, the intermediate light-extinction structure 141 can be set to have multiple side edges, and the length of a shortest side edge of the intermediate light-extinction structure is within 0.01 mm˜0.3 mm. Within this parameter range, arrangement of the intermediate light-extinction structure 141 can be ensured to be optimized.

Furthermore, after the light-extinction structure 131 and the intermediate light-extinction structure 141 are disposed at the light-extinction surface 12, a light-extinction treatment can be performed on circumference side regions of the light-transmission region 11. However, in practical production and application, the light-extinction treatment does not need to be performed on all circumference sides of the light-transmission region 11. Therefore, reasonable control of the size of a light-extinction region can effectively reduce production costs, which can not only avoid unnecessary investment, but also optimize the light-extinction effect.

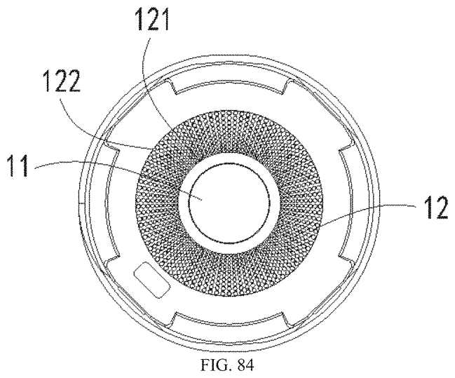

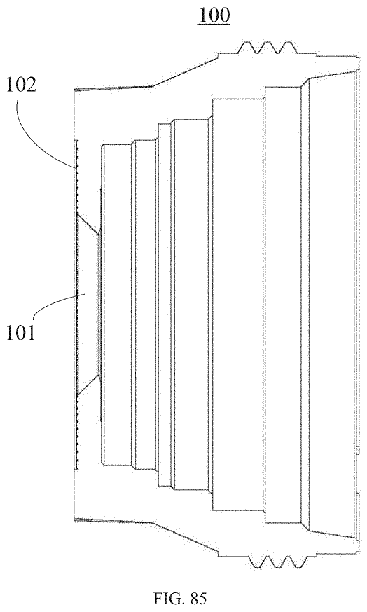

Reference can be made to FIG. 84, a boundary of the light-extinction surface 12 adjacent to the light-transmission region 11 can be defined as an inner boundary 121, and a distance between the inner boundary 121 and a center of the light-transmission region 11 ranges from 1 mm to 5 mm. Since the inner boundary 121 is substantially arranged as a circle in this case, it can also be understood that a diameter of the circle enclosed by the inner boundary 121 ranges from 1 mm to 5 mm, that is, the light-extinction structure 131 and the intermediate light-extinction structure 141 do not need to be disposed at a region between the inner boundary 121 and the light-transmission region 11, which ensures rationalization of arrangement of the light-extinction surface 12.

Similarly, reference can be made to FIG. 84, a boundary of the light-extinction surface 12 away from the light-transmission region 11 can be defined as an outer boundary 122, and a distance between the outer boundary 122 and a center of the light-transmission region 11 ranges from 2 mm to 15 mm. Since the outer boundary 122 is substantially arranged as a circle in this case, it can also be understood that a diameter of the circle enclosed by the outer boundary 122 ranges from 2 mm to 15 mm, that is, the light-extinction structure 131 and the intermediate light-extinction structure 141 do not need to be disposed at a region outside the outer boundary 122, which also provides a guarantee for rationalization of arrangement of the light-extinction surface 12.

In addition to the above low-reflection structure, a lens barrel is also provided in the implementations of the present disclosure, and the lens barrel includes the above low-reflection structure. Referring to FIG. 85, the lens barrel 100 defines a lens hole 101 and has a top surface 102 arranged around a circumference side of the lens hole, the light-transmission region of the low-reflection structure is the lens hole, and the light-extinction surface of the low-reflection structure is the top surface.

The lens barrel generally has a substantially cylindrical structure, and the lens hole penetrates through the lens barrel in a center axial direction of the lens barrel, such that light can pass through the lens barrel through the lens hole. One end of the lens barrel is the top surface. In this case, since the light-transmission region of the low-reflection structure is the lens hole and the light-extinction surface of the low-reflection structure is the top surface, the above light-extinction structure 131 and the above intermediate light-extinction structure 141 will be disposed at the top surface. When light passes through the lens barrel, the top surface can perform a light-extinction treatment.

In addition to the above low-reflection structure, a lens is also provided in the implementations of the present disclosure, and the lens includes the above low-reflection structure. The lens has a light-passing region and a lens plane arranged around a circumference side of the light-passing region, the light-transmission region of the low-reflection structure is the light-passing region, and the light-extinction surface of the low-reflection structure is the lens plane.

The lens generally has a substantially sheet-like structure, a region on the lens where light can penetrate through is the light-passing region, such that light can pass through the lens. The circumference side of the light-passing region is the lens plane. Generally, a whole lens can transmit light, however during use, the lens is configured to match with accessories of the lens barrel, as long as light can pass through the lens barrel, in other words, the lens does not have to transmit light at all parts. If light-extinction is performed on parts of the lens needing no light transmission, the light-extinction effect can be improved.

Therefore, in this case, the light-transmission region of the low-reflection structure is the light-passing region, and the light-extinction surface of the low-reflection structure is the lens plane, in other words, it is equivalent to disposing the light-extinction structure 131 and the intermediate light-extinction structure 141 at partial positions of the lens, such that the light-extinction treatment can be performed when light passes through the lens.

In addition to the above low-reflection structure, a spacer is also provided in the implementations of the present disclosure, and the spacer includes the above low-reflection structure. The spacer defines a through hole and has a base surface arranged around a circumference side of the through hole, the light-transmission region of the low-reflection structure is the through hole, and the light-extinction surface of the low-reflection structure is the base surface.

The spacer generally has a ring-shaped structure, a central region of the spacer is the through hole, and the circumference side of the through hole is the base surface. During use, the spacer is generally arranged between the lens barrel and other accessories, and the through hole of the spacer will be aligned with the lens plane to ensure that light can pass through the lens barrel successfully.

Therefore, in this case, the light-transmission region of the low-reflection structure is the through hole, and the light-extinction surface of the low-reflection structure is the base surface, in other words, it is equivalent to disposing the light-extinction structure 131 and the intermediate light-extinction structure 141 at the base surface, such that the light-extinction treatment can be performed when light passes through the spacer.

It should be noted that the above lens barrel, lens, and spacer all can be applicable to an image-taking module, therefore, an image-taking module is further provided in the implementations of the present disclosure, the image-taking module includes an image-taking chip and the above lens barrel, where an image-taking region of the image-taking chip is aligned with the lens hole of the lens barrel; or an image-taking module includes an image-taking chip and the above lens, where an image-taking region of the image-taking chip is aligned with the light-passing region of the lens; or an image-taking module includes an image-taking chip and the above spacer, where an imaging-taking region of the image-taking chip is aligned with the through hole of the spacer, such that an image-taking module with excellent the light-extinction effect is obtained.

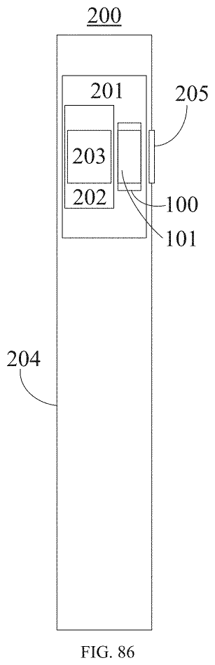

Similarly, after the above image-taking module is applicable to an electronic device, the electronic device includes a housing and the above image-taking module. The housing defines an image-taking hole, the image-taking module is disposed in a space enclosed by the housing, and the image-taking region of the image-taking module is arranged opposite to the image-taking hole, such that an electronic device with excellent light-transmission effect is obtained. As illustrated in FIG. 86, the electronic device 200 includes a housing 204 and an image-taking module 201. The image-taking module 201 includes an image-taking chip 202 and the lens barrel 100. The housing 204 defines an image-taking hole 205, the image-taking module 202 is disposed in a space enclosed by the housing, and the image-taking region 204 of the image-taking module 201 is arranged opposite to the image-taking hole 205.

In this case, an electronic device has various choices, such as a mobile phone, a smart watch, a tablet computer, a handheld computer, etc., which can be selected and used according to production requirements.

The above are the preferable implementations of the present disclosure. It should be noted that, for those of ordinary skill in the art, without departing from a concept of the present disclosure, several modifications and improvements can be made, and these modifications and improvements all fall within the protection of scope of the present disclosure.

What is claimed is:

1. A low-reflection structure, comprising:
a light-transmission region; and
a light-extinction surface arranged around a circumference side of the light-transmission region, wherein a plurality of light-extinction groups are disposed at the light-extinction surface, the plurality of light-extinction groups are arranged circumferentially around the light-transmission region, each light-extinction group has a plurality of light-extinction structures, and the plurality of light-extinction structures of each light-extinction group are all arranged in a radial direction of the light-transmission region.

2. The low-reflection structure of claim 1, wherein the plurality of light-extinction structures of each light-extinction group are arranged at regular intervals.

3. The low-reflection structure of claim 2, wherein a distance between adjacent light-extinction structures ranges from 0.005 mm to 0.1 mm, in the radial direction of the light-transmission region.

4. The low-reflection structure of claim 1, wherein a light-extinction structure is a boss protrudingly formed from the light-extinction surface.

5. The low-reflection structure of claim 4, wherein a height of the light-extinction structure ranges from 0.005 mm to 0.1 mm.

6. The low-reflection structure of claim 4, wherein a draft angle is defined between a side surface of the light-extinction structure and the light-extinction surface, and the draft angle of the light-extinction structure ranges from 0° to 20°.

7. The low-reflection structure of claim 1, wherein a light-extinction structure is a groove depressively defined from the light-extinction surface.

8. The low-reflection structure of claim 1, wherein a light-extinction structure adjacent to the light-transmission region is smaller than a light-extinction away from the light-transmission region for each two adjacent light-extinction structures in each light-extinction group, to define an included angle of 1°˜30° between adjacent light-extinction groups.

9. The low-reflection structure of claim 8, wherein a plurality of intermediate light-extinction groups are further disposed at the light-extinction surface, and an intermediate light-extinction group is disposed between adjacent light-extinction groups; and
each intermediate light-extinction group has a plurality of intermediate light-extinction structures, and the plurality of intermediate light-extinction structures of each intermediate light-extinction group are all arranged in the radial direction of the light-transmission region.

10. The low-reflection structure of claim 9, wherein the plurality of intermediate light-extinction structures of each intermediate light-extinction group are arranged at regular intervals.

11. The low-reflection structure of claim 9, wherein an intermediate light-extinction structure is a boss protrudingly formed from the light-extinction surface.

12. The low-reflection structure of claim 9, wherein an intermediate light-extinction structure is a groove depressively defined from the light-extinction surface.

13. The low-reflection structure of claim 9, wherein a light-extinction structure and an intermediate light-extinction structure are arranged in alternation in the radial direction of the light-transmission region.

14. The low-reflection structure of claim 9, wherein a light-extinction structure and an intermediate light-extinction structure are arranged in alternation in a circumferential direction around the light-transmission region.

15. The low-reflection structure of claim 1, wherein a boundary of the light-extinction surface adjacent to the light-transmission region is an inner boundary, and a distance between the inner boundary and a center of the light-transmission region ranges from 1 mm to 5 mm.

16. The low-reflection structure of claim 1, wherein a boundary of the light-extinction surface away from the light-transmission region is an outer boundary, and a distance between the outer boundary and a center of the light-transmission region ranges from 2 mm to 15 mm.

17. The low-reflection structure of claim 1, wherein a light-extinction structure comprises a boss protrudingly formed from the light-extinction surface and a groove depressively defined from the light-extinction surface, and a boss-shaped light-extinction structure and a groove-shaped light-extinction structure are arranged in alternation in the radial direction of the light-transmission region.

18. The low-reflection structure of claim 17, wherein the boss-shaped light-extinction structure and the groove-shaped light-extinction structure are arranged in alternation in a circumferential direction around the light-transmission region.

19. A lens barrel, comprising:
a low-reflection structure, comprising:
a lens hole; and
a top surface arranged around a circumference side of the lens hole, wherein a plurality of light-extinction groups are disposed at the top surface, the plurality of light-extinction groups are arranged circumferentially around the lens hole, each light-extinction group has a plurality of light-extinction structures, and the plurality of light-extinction structures of each light-extinction group are all arranged in a radial direction of the lens hole.

20. An electronic device, comprising:
a housing; and
an image-taking module comprising an image-taking chip and a lens barrel, wherein the lens barrel comprises a low-reflection structure; wherein,
the low-reflection structure comprises:
a lens hole; and
a top surface arranged around a circumference side of the lens hole, wherein a plurality of light-extinction groups are disposed at the top surface, the plurality of light-extinction groups are arranged circumferentially around the lens hole, each light-extinction group has a plurality of light-extinction structures, and the plurality of light-extinction structures of each light-extinction group are all arranged in a radial direction of the lens hole;
an image-taking region of the image-taking chip is aligned with the lens hole of the lens barrel; and
the housing defines an image-taking hole, the image-taking module is disposed in a space enclosed by the housing, and the image-taking region of the image-taking module is arranged opposite to the image-taking hole.
